(19) United States
(12) Patent Application Publication
(10) Pub. No.: US 2026/0179540 A1
(43) Pub. Date: Jun. 25, 2026

(54) PIXEL CIRCUIT

(71) Applicant: Shanghai AVIC Optoelectronics Co., Ltd., Shanghai (CN)

(72) Inventors: Jiro YANASE, Kawasaki (JP); Masamichi SHIMODA, Kawasaki (JP); Genshiro KAWACHI, Kawasaki (JP)

(73) Assignee: Shanghai AVIC Optoelectronics Co., Ltd., Shanghai (CN)

(21) Appl. No.: 19/407,465

(22) Filed: Dec. 3, 2025

(30) Foreign Application Priority Data
Dec. 25, 2024 (JP) 2024-228546
Oct. 2, 2025 (JP) 2025-166261

(51) Int. Cl. G09G 3/32; G09G 3/20

(52) U.S. Cl. CPC G09G 3/32; G09G 3/2007; G09G 2300/0819; G09G 2300/0852; G09G 2310/08

(57) ABSTRACT

A pixel circuit includes a constant current control circuit including a first thin-film transistor. The constant current control circuit is configured to control current that flows in the light-emitting element. The pixel circuit includes a pulse width modulation circuit configured to output a control signal for the first thin-film transistor based on a gray-level data voltage and a ramp signal input to the pulse width modulation circuit. The first thin-film transistor is configured to control the current that flows in the light-emitting element. The pulse width modulation circuit includes a pulse width modulation driving thin-film transistor, and a second thin-film transistor disposed between the pulse width modulation driving thin-film transistor and an output node of the control signal. A gate of the second thin-film transistor is configured to be supplied with a constant voltage.

### CROSS-REFERENCE TO RELATED APPLICATIONS

This non-provisional application claims priority under 35 U.S.C. § 119(a) on Patent Application No. 2024-228546 filed in Japan on Dec. 25, 2024 and Patent Application No. 2025-166261 filed in Japan on Oct. 2, 2025, the entire contents of which are hereby incorporated by reference.

### BACKGROUND

This disclosure relates to a pixel circuit.

Display devices utilizing micro-light-emitting diodes (micro-LEDs) employ pulse width modulation (PWM) driving that modulates their emission periods to display halftones. Among a plurality of methods of PWM driving, analog PWM driving that changes the emission pulse width in an analog manner in accordance with gray-level data has been standardized in recent years.

The pixel circuit to be driven by the analog PWM includes a constant current generation (CCG) unit, a PWM unit, and a switch. The CCG unit generates a constant current. The PWM unit compares a gray-level data voltage representing gray-level data with a ramp signal and converts the gray level data voltage to a pulse signal. The switch cuts off the current generated by the CCG unit when the pulse signal from the PWM unit changes in accordance with the width of this pulse signal.

The analog PWM driving requires rectangular pulses for the ideal driving current; however, the current by the actual circuit falls gently, raising an issue such that its finite falling time (transition time) causes degradation in display quality, especially in the low gray-level range.

### SUMMARY

An aspect of this disclosure is a pixel circuit configured to control a light-emitting element. The pixel circuit includes a constant current control circuit including a first thin-film transistor. The constant current control circuit is configured to control current that flows in the light-emitting element. The pixel circuit includes a pulse width modulation circuit configured to output a control signal for the first thin-film transistor based on a gray-level data voltage and a ramp signal input to the pulse width modulation circuit. The first thin-film transistor is configured to control the current that flows in the light-emitting element. The pulse width modulation circuit includes a pulse width modulation driving thin-film transistor, and a second thin-film transistor disposed between the pulse width modulation driving thin-film transistor and an output node of the control signal. A gate of the second thin-film transistor is configured to be supplied with a constant voltage.

It is to be understood that both the foregoing general description and the following detailed description are exemplary and explanatory and are not restrictive of this disclosure.

### BRIEF DESCRIPTION OF THE DRAWINGS

FIG. 1 schematically illustrates the configuration of a pixel circuit in an embodiment of this disclosure.

FIG. 2 illustrates temporal variation of input signal voltages VRAMP and VDATA input to a PWM circuit, control signal voltage VOUT output from the PWM circuit, and driving current ILED to a micro-LED.

FIG. 3A illustrates the state of a pixel circuit at the time T1 in FIG. 2.

FIG. 3B illustrates the state of a pixel circuit at the time T2 in FIG. 2.

FIG. 3C illustrates the state of a pixel circuit at the time T3 in FIG. 2.

FIG. 3D illustrates the state of a pixel circuit at the time T4 in FIG. 2.

FIG. 3E illustrates the state of a pixel circuit at the time T5 in FIG. 2.

FIG. 4 schematically illustrates the waveforms of a ramp signal VRAMP and LED currents ILED in response to different gray-level data voltages.

FIG. 5 illustrates a pixel circuit of a related art configured by removing the supplemental thin-film transistor from the pixel circuit in FIG. 1.

FIG. 6 illustrates characteristics of the pixel circuit of the related art.

FIG. 7 illustrates the detailed configuration example of a pixel circuit in an embodiment.

FIG. 8A is a sequence diagram illustrating temporal variation in one frame of signals in a pixel circuit.

FIG. 8B indicates the temporal variation of the signals in the period surrounded by a broken line in one graph in FIG. 8A and the temporal variation of the signals in the period surrounded by a broken line in another graph in FIG. 8A.

FIG. 9 illustrates a simplified circuit configuration of the pixel circuit illustrated in FIG. 7.

FIG. 10A is a diagram to explain the function of the supplemental thin-film transistor.

FIG. 10B provides simulation results on the Id-Vd characteristic of a pixel circuit without a supplemental thin-film transistor and a pixel circuit with a supplemental thin-film transistor.

FIG. 11 is a chart to explain the effects of the pixel circuit 10 in an embodiment of this disclosure.

FIG. 12 provides simulated waveforms of the gate voltage, the source voltage, and the drain voltage of the supplemental thin-film transistor in the embodiment.

FIG. 13A provides a simulation result on the relation between the constant voltage VREF and the falling time of the LED current ILED when a power-supply voltage VH2 at 9 V is supplied to the PWM circuit in a pixel circuit in Embodiment 2.

FIG. 13B provides a simulation result on the relation between the constant voltage VREF and the falling time of the LED current ILED when a power-supply voltage VH2 at 5 V is supplied to the PWM circuit in the pixel circuit.

FIG. 13C provides a simulation result on the relation between the constant voltage VREF and the falling time of the LED current ILED when a power-supply voltage VH2 at 1 V is supplied to the PWM circuit in the pixel circuit.

FIG. 14 illustrates a configuration example of a pixel circuit in the case where the positive power-supply voltage VH2 for the PWM circuit is 9 V.

FIG. 15 illustrates a configuration example of a pixel circuit in the case where the positive power-supply voltage VH2 for the PWM circuit is 1 V.

FIG. 16 provides simulation results on the relation between the capacitance C of a capacitor and the falling time in Embodiment 3.

FIG. 17 provides simulation results on the LED current ILED in the cases where different capacitances C are employed in a pixel circuit including a supplemental thin-film transistor in the embodiment.

FIG. 18 illustrates an example in Embodiment 4 where the p-type transistors in the simplified pixel circuit illustrated in FIG. 9 are replaced with n-type thin-film transistors.

FIG. 19 provides a simulation result on the relation between the channel length of a PWM driving thin-film transistor and the falling time of the LED current in Embodiment 5.

FIG. 20 is a circuit diagram illustrating the configuration of a PWM driving thin-film transistor having a double-gate structure.

FIG. 21 is a plan diagram illustrating a configuration example of a micro-LED display device.

FIG. 22 schematically illustrates the configuration of a pixel circuit in another embodiment of this disclosure.

FIG. 23 illustrates temporal variation of the LED current, the drain voltage of the PWM driving thin-film transistor, and the gate voltage of the constant current driving thin-film transistor in the pixel circuit illustrated in FIG. 22.

FIG. 24 schematically illustrates the configuration of a pixel circuit in still another embodiment of this disclosure.

FIG. 25 schematically illustrates the configuration of a pixel circuit in still another embodiment of this disclosure.

FIG. 26 illustrates temporal variation of the LED current, the drain voltage of the PWM driving thin-film transistor, and the gate voltage of the constant current driving thin-film transistor in the pixel circuit illustrated in FIG. 25.

FIG. 27 provides a simulation result on the relation between the falling time of the LED current and the constant voltage DIVH in the pixel circuit illustrated in FIG. 25.

FIG. 28A provides simulation results on the pixel circuit illustrated in FIG. 22.

FIG. 28B provides simulation results on the pixel circuit illustrated in FIG. 25.

FIG. 29A provides simulation results on the pixel circuit illustrated in FIG. 22.

FIG. 29B provides simulation results on the pixel circuit illustrated in FIG. 25.

FIG. 30 schematically illustrates the configuration of a pixel circuit in still another embodiment of this disclosure

### EMBODIMENTS

An aspect of this disclosure describes control of light emission of a micro-light-emitting diode (micro-LED). The pixel circuit for controlling light emission of a micro-LED lights the micro-LED for an emission period having a length in accordance with gray-level data and then stops lighting the micro-LED in one frame period. A longer emission period means higher brightness. One frame period is a period to display one frame in the video data (for either a motion picture or a still image) input from the external of the display device.

An embodiment of this disclosure controls the emission period (brightness) of a micro-LED by pulse width modulation (PWM) in accordance with gray-level data. The method of driving a micro-LED by PWM control (PWM driving) supplies pulsed driving current (also referred to as lighting current or LED current) having a pulse width in accordance with gray-level data to the micro-LED to light the micro-LED.

The pulse width is a length between the medians in the rise and the fall of a pulse of the driving current; a longer pulse width means a longer emission period or higher brightness. The driving current for a low gray-level range does not reach the highest value for a high gray-level range; its waveform may consist of a steep rising edge and a gentle falling edge.

The analog PWM driving requires a rectangular waveform for the ideal driving current. However, the current by the actual circuit falls gently; a finite falling time (transition region) exists where the driving current value decreases little by little. During the falling time, the driving current gradually decreases.

The emission wavelength of a micro-LED shifts to a shorter wavelength with increase in density of the driving current and then, shifts toward a longer wavelength with further increase. The external quantum efficiency (EQE) of a micro-LED significantly degrades when the driving current density is low. Especially in the case where the supply period of the driving current for a low gray level only consists of a falling time, the adverse effect onto the emission of the micro-LED is high. Accordingly, the length of this falling time is a major issue in the PWM driving of a micro-LED.

The pixel circuit in an embodiment of this disclosure includes a supplemental thin-film transistor between the output node of the PWM circuit and the driving thin-film transistor. The gate of the supplemental thin-film transistor is supplied with a constant voltage in one frame period. The supplemental thin-film transistor reduces the falling time of the driving current for the micro-LED.

In a circuit, two circuit elements can be connected directly without a circuit element therebetween (excluding a line) or via one or more circuit elements therebetween. To distinguish the connection of two circuit elements via or not via other circuit elements, the connection may be referred to as circuit connection or electrical connection. To distinguish the connection without any circuit element therebetween, the connection may be referred to as direct connection or physical connection.

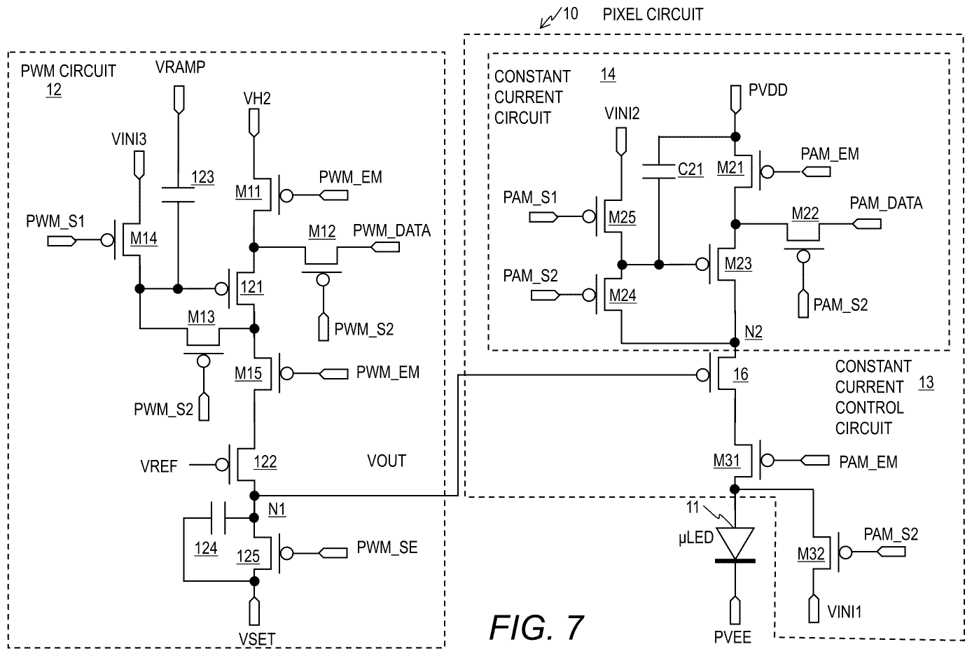

Taking an example of M15 in FIG. 7, its gate is connected to PWM_EM. When PWM_EM is low, the gate-source voltage of M15 is sufficiently high; M15 is fully ON. The current flowing from the power line for the positive power-supply voltage VH2 to VOUT within the PWM circuit 12 is as minute as 20 nA at a maximum; the absolute value of the voltage drop (of Vds) at M15 is approximately 0.5 mV, which is small enough to be ignored, compared to 13 V of the absolute value of the voltage between the positive power-supply voltage VH2 and VOUT of the PWM circuit 12. In other words, when M15 is fully turned ON and the voltage drop (of Vds) due to M15 may be ignored, then even if M15 is actually used, the circuit symbol of M15 may be omitted from the circuit diagram and explanation of the operation of M15 may be omitted. In the following description, connection in a circuit means electrical connection or circuit connection unless stated otherwise.

### Embodiment 1

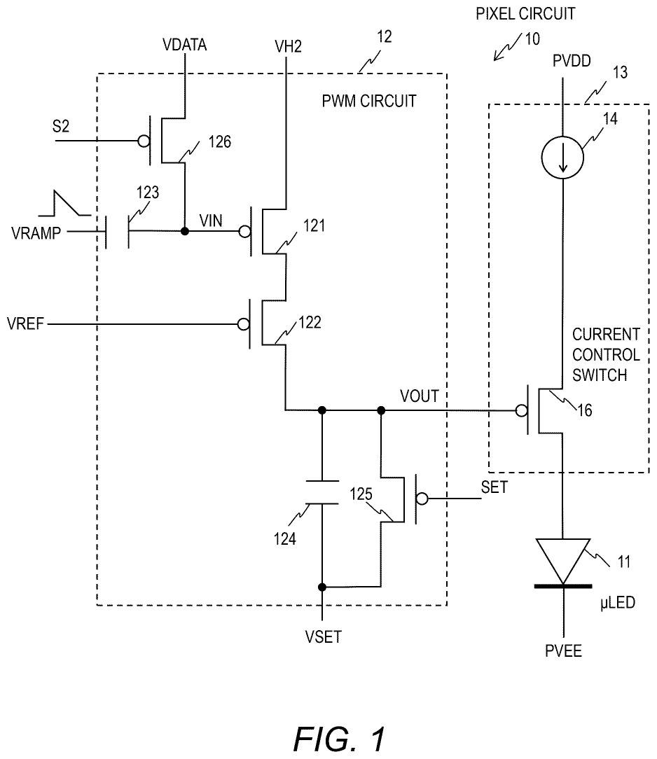

FIG. 1 schematically illustrates the configuration of a pixel circuit in an embodiment of this disclosure. The pixel circuit of this disclosure can include other elements in addition to the elements shown in FIG. 1 and/or exclude one or more of the elements shown in FIG. 1. The direct connection of circuit elements in FIG. 1 can be electrical or circuit connection.

The display region of a display device includes micro-LEDs (μLEDs) 11 arrayed in a predetermined layout, for example, in a matrix. The micro-LEDs 11 are light-emitting elements or pixels. The features of this disclosure can be applied to light-emitting elements of the kinds different from the micro-LED. The display device includes pixel circuits 10 for individually controlling the micro-LEDs 11. Each pixel circuit 10 includes a constant current circuit 14, a PWM circuit 12, and a current control switch 16 (an example of a first thin-film transistor). The constant current circuit 14 and the current control switch 16 are included in a constant current control circuit 13.

All micro-LEDs 11 may be for the same color of light or the display region can include micro-LEDs 11 for different colors of light, for example, red light, blue light, and green light. In this example, one micro-LED 11 corresponds to a single pixel.

A micro-LED 11 includes an anode and a cathode. The cathode of the micro-LED 11 is supplied with a constant power-supply voltage PVEE. The constant current circuit 14 can have any internal configuration. The constant current circuit 14 generates a constant current. The current control switch 16 is provided between the micro-LED 11 and the constant current circuit 14. The current control switch 16 is a thin-film transistor (also simply referred to as transistor) and in the configuration example of FIG. 1, it is a p-type thin-film transistor. The active layer of the p-type thin-film transistor can be made of low-temperature polysilicon, for example.

In the configuration example of FIG. 1, the source of the current control switch 16 is connected to the constant current circuit 14 and the drain is connected to the anode of the micro-LED 11. The current control switch 16 is disposed on the path of the current that flows from the constant current circuit 14 to the power line for supplying a power-supply voltage PVEE via the micro-LED 11 to turn ON/OFF the path.

The current control switch 16 can be disposed between the micro-LED 11 and the power line for supplying the power-supply voltage PVEE. The current control switch 16 can be an n-type thin-film transistor. The active layer of the n-type thin-film transistor can be made of oxide semiconductor or low-temperature polysilicon, for example.

The PWM circuit 12 includes a PWM driving thin-film transistor 121, a supplemental thin-film transistor 122 (an example of a second thin-film transistor), capacitors 123 and 124, and switching thin-film transistors 125 and 126. The PWM driving thin-film transistor 121 works as a comparator.

One source/drain of the switching thin-film transistor 126 and one end of the capacitor 123 are connected to the gate of the PWM driving thin-film transistor 121. In a thin-film transistor, the source and the drain interchange depending on the direction of the electric current; therefore, either one is referred to as a source/drain.

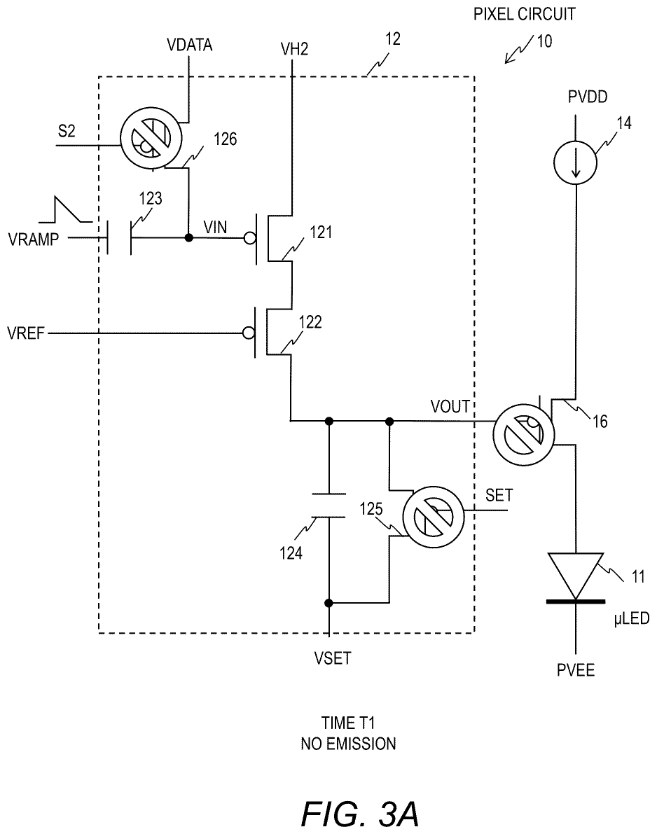

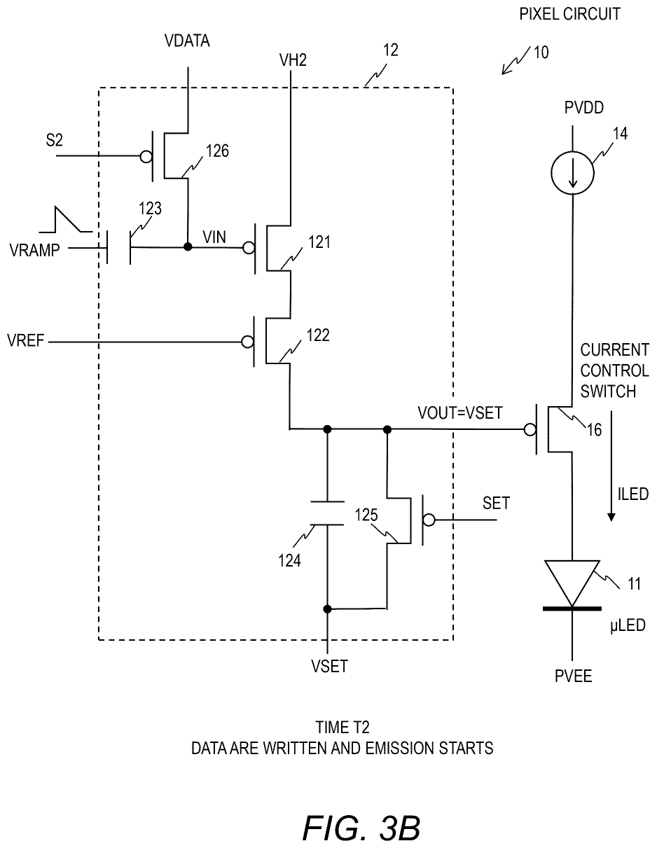

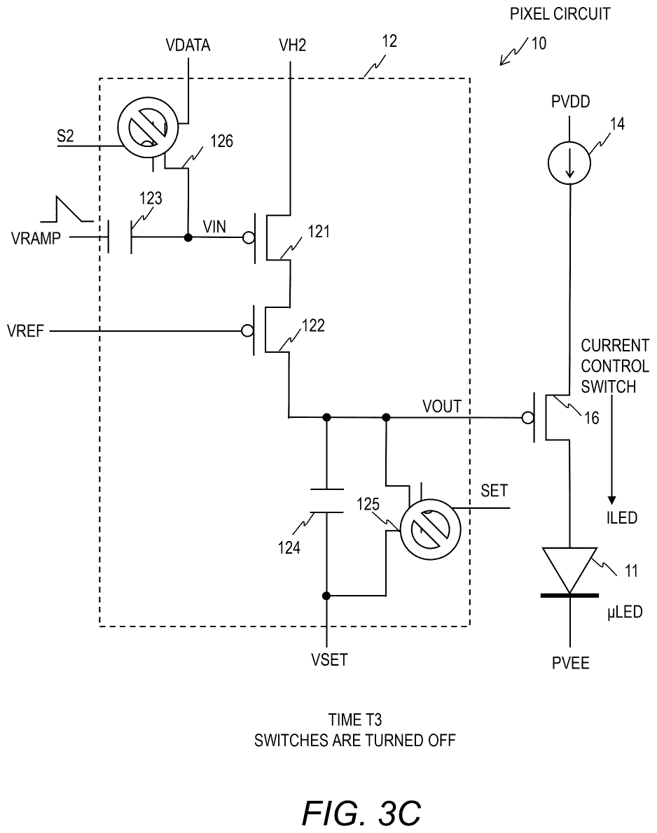

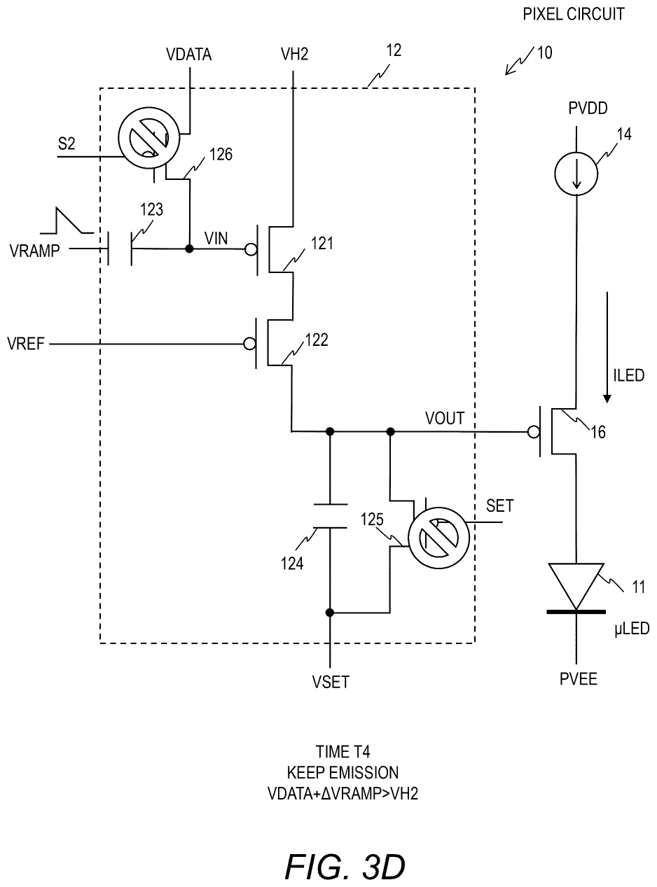

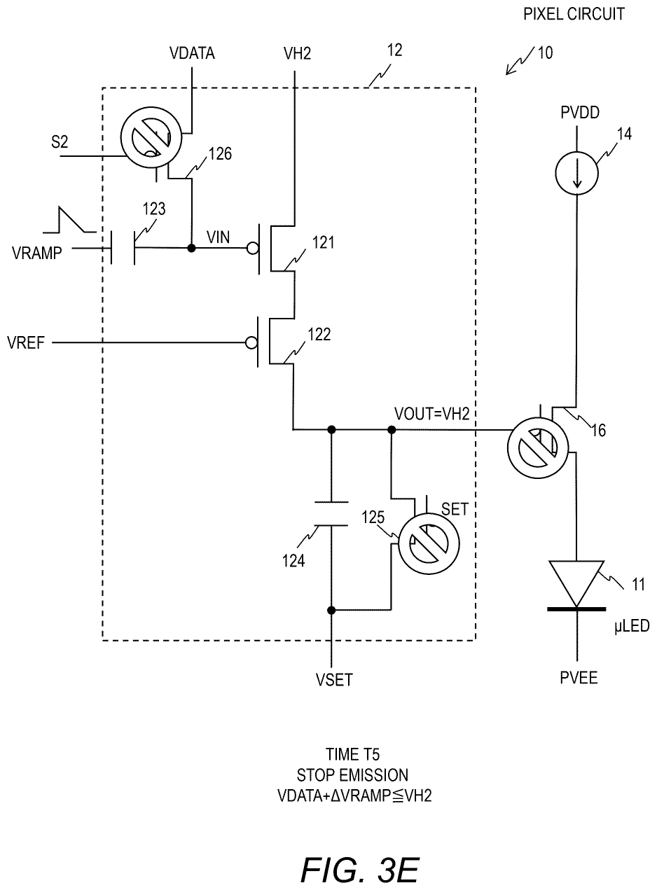

One source/drain of the switching thin-film transistor 125 and one end of the capacitor 124 are connected to the gate of the current control switch 16. The gate of the switching thin-film transistor 126 is supplied with a control signal S2 and the gate of the switching thin-film transistor 125 is supplied with a control signal SET. The switching thin-film transistors 126 and 125 are controlled by the control signals S2 and SET as will be described with reference to FIGS. 3A to 3E.

The gate of the PWM driving thin-film transistor 121 corresponds to an inverting input of a comparator and it is supplied with an input signal voltage VIN. The source of the thin-film transistor 121 is supplied with a constant voltage (high voltage) VH2.

The drain of the PWM driving thin-film transistor 121 is connected to the source of the supplemental thin-film transistor 122. The drain of the supplemental thin-film transistor 122 is connected to the gate of the current control switch 16. The PWM driving thin-film transistor 121 outputs a control signal voltage VOUT for controlling ON/OFF of the current control switch 16 through the supplemental thin-film transistor 122.

Although all thin-film transistors included in the pixel circuit 10 in FIG. 1 are p-type thin-film transistors, one or more, even all of the thin-film transistors can be n-type thin-film transistors. This configuration such that all thin-film transistors in the backplane have a single polarity leads to low manufacturing cost. The pixel circuit 10 can further include elements such as a thin-film transistor and a capacitor in addition to the elements shown in FIG. 1 and/or exclude some elements from the elements shown in FIG. 1. The same applies to the control signals for the pixel circuit 10; one or more kinds of control signals can be added and/or one or more of the signals can be excluded.

The PWM driving thin-film transistor 121 compares the input signal voltage VIN to the gate with the constant voltage VH2 to the source and outputs an output signal voltage VOUT indicating the comparison result through the supplemental thin-film transistor 122. The gate of the supplemental thin-film transistor 122 is supplied with a constant voltage VREF. The output signal voltage VOUT is supplied to the gate of the current control switch 16 as a control signal voltage for controlling ON/OFF of the current control switch 16.

The switching thin-film transistor 126 switches ON/OFF the path between the transmission line for a gray-level data voltage VDATA and the gate of the PWM driving thin-film transistor 121. The other end of the capacitor 123 is supplied with a ramp signal VRAMP. The ramp signal VRAMP is a voltage that linearly increases or decreases with time and the gray-level data voltage VDATA is a voltage in accordance with the gray level of a pixel of a video frame. The examples of the ramp signal described in the following are mainly ramp signals whose voltages decrease but ramp signals whose voltages increase can also be used. In the case where the polarity of the transistor is the p-type, the state of the transistor changes from OFF to ON as the ramp signal falls.

The capacitor 124 is configured between the gate of the current control switch 16 and the line (power line) for supplying a constant voltage VSET. The constant voltage VSET is lower than the constant voltage VH2. One end of the capacitor 124 is connected to a node between the gate of the current control switch 16 and a source/drain (the comparator output) of the supplemental thin-film transistor 122. The other end is connected to the line for supplying the constant voltage VSET.

The switching thin-film transistor 125 switches ON/OFF the path between the gate of the current control switch 16 and the line for supplying the constant voltage VSET. One end of the switching thin-film transistor 125 is connected to a node between the gate of the current control switch 16 and the output of the PWM circuit 12 and the other end is connected to the line for supplying the constant voltage VSET. The switching thin-film transistor 125 writes the voltage VSET (Low) to the voltage VOUT to turn ON the current control switch 16.

The PWM circuit 12 controls the width of the control signal voltage VOUT based on the gray-level data voltage VDATA and outputs the control signal voltage VOUT. The signal voltage input to the PWM circuit 12 includes the gray-level data voltage VDATA and the variation ΔVRAMP of the ramp signal. The PWM circuit 12 compares the gray-level data voltage VDATA representing the gray-level data with the variation ΔVRAMP of the ramp signal. In response to the PWM driving thin-film transistor 121 turning ON, the control signal voltage VOUT changes.

The PWM circuit 12 in FIG. 1 compares the summed voltage of the gray-level data voltage VDATA and the variation ΔVRAMP of the ramp signal with the constant voltage VH2 using the PWM driving thin-film transistor 121 and outputs a control signal voltage VOUT in accordance with the magnitude relation therebetween through the supplemental thin-film transistor 122. This operation corresponds to the comparison of the gray-level data voltage VDATA with the variation ΔVRAMP of the ramp signal VRAMP. The PWM circuit 12 turns OFF the current control switch 16 by outputting a high (H) level voltage VH2 with the PWM driving thin-film transistor 121 and the supplemental thin-film transistor 122 to stop the supply of the current to the micro-LED 11.

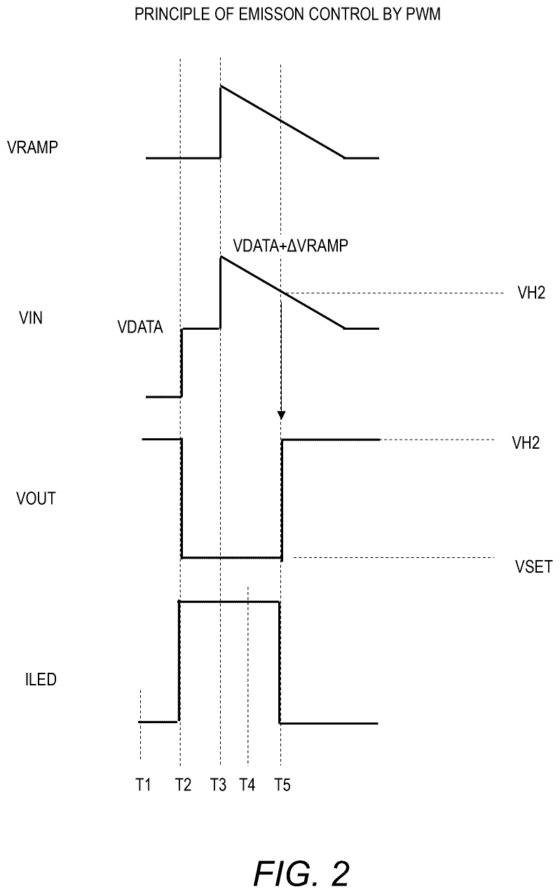

FIG. 2 illustrates temporal variation of the input signal voltages VRAMP and VDATA input to the PWM circuit 12, the control signal voltage VOUT output from the PWM circuit 12, and the driving current ILED to the micro-LED 11. The input signal voltage VIN to the PWM driving thin-film transistor 121 is the summed voltage of the gray-level data voltage VDATA and the variation ΔVRAMP of the ramp signal VRAMP. 75 FIGS. 3A to 3E illustrate the states of a pixel circuit 10 at the times T1 to T5 in FIG. 2. Hereinafter, circuit operation of the pixel circuit 10 is described with reference to FIGS. 2 and 3A to 3E.

With reference to FIG. 3A illustrating the state at the time T1, the micro-LED 11 does not emit light. The time T1 is included in a non-emission period. The switching thin-film transistors 126 and 125 are OFF. With reference to FIG. 2, the control signal voltage VOUT from the PWM circuit 12 at the time T1 is the H-level of VH2. The current control switch 16 is OFF and accordingly, the driving current ILED to the micro-LED 11 is cut off.

With reference to FIG. 3B illustrating the state at the time T2, the switching thin-film transistors 126 and 125 are turned ON. With reference to FIG. 2, the gray-level data voltage VDATA corresponding to the gray level in the video frame data is written to the PWM circuit 12 at the time T2. The period from the time T2 to the time T3 is a period to write the gray-level data voltage. Since the switching thin-film transistor 125 is ON, the control signal voltage VOUT from the PWM circuit 12 is the L-level of VSET. Accordingly, the current control switch 16 is ON; the driving current ILED is supplied to the micro-LED 11 and the micro-LED 11 starts emitting light. Note that the switching thin-film transistors 125 and 126 can be turned ON at different times in the period from the time T2 to the time T3.

With reference to FIG. 3C illustrating the state at the time T3, the switching thin-film transistor 126 and 125 are turned OFF. With reference to FIG. 2, the ramp signal VRAMP starts to be input at the time T3. The summed voltage of the gray-level data voltage VDATA and the variation ΔVRAMP of the ramp signal is higher than the voltage VH2. The control signal voltage VOUT from the PWM circuit 12 is maintained at VSET of the L-level. The current control switch 16 keeps ON and the micro-LED 11 keeps emitting light.

With reference to FIG. 3D illustrating the state at the time T4, the switching thin-film transistors 126 and 125 remain OFF. With reference to FIG. 2, the summed voltage of the gray-level data voltage VDATA and the variation ΔVRAMP of the ramp signal is higher than the voltage VH2. The control signal voltage VOUT from the PWM circuit 12 is maintained at VSET of the L-level. The current control switch 16 keeps ON and the micro-LED 11 keeps emitting light.

With reference to FIG. 3E illustrating the state at the time T5, the switching thin-film transistors 126 and 125 remain OFF. With reference to FIG. 2, the summed voltage of the gray-level data voltage VDATA and the variation ΔVRAMP of the ramp signal has decreased to the voltage VH2. Assuming that the threshold voltage of the PWM driving thin-film transistor 121 is 0 V for simplicity, the PWM driving thin-film transistor 121 turns ON and the control signal voltage VOUT from the PWM circuit 12 changes from VSET of the L-level to VH2 of the H-level. In response to the change of the control signal voltage VOUT, the current control switch 16 is turned OFF and the micro-LED 11 stops emitting light.

As described above, the pulse width of the driving current for the micro-LED 11 depends on the gray-level data voltage VDATA. In other words, the emission period of the micro-LED 11 is controlled by the gray-level data voltage VDATA.

In FIG. 2, the driving current ILED for the micro-LED 11 falls steeply at the time T5. This waveform is an ideal one and actually, the driving current ILED falls more gently. Unlike the falling edge, the rising edge of the driving current ILED has an almost ideal steep gradient. This can be achieved by providing a switching thin-film transistor not shown in FIG. 1 on the path of the LED current. The voltage of the control signal to the gate of the switching thin-film transistor is a signal output from a gate driver and it can be changed steeply from high to low in the order of sub-microseconds. For this reason, the driving current ILED can rise with an almost ideal steep gradient.

In a conventional configuration, the driving current ILED slowly and gradually decreases from the maximum value to zero. The driving current ILED driven by the conventional constant current PWM is not cut off instantly, providing a period where the driving current ILED is not constant. The ideal constant current PWM driving is not accomplished. As for the pulse width modulation for a micro-LED 11, a long falling time

of the driving current ILED, especially for the low-gray-level region, may cause considerable variations in emission efficiency and chromaticity among micro-LEDs. As a result, the display quality degrades. This is because the LED current has low density in the falling time.

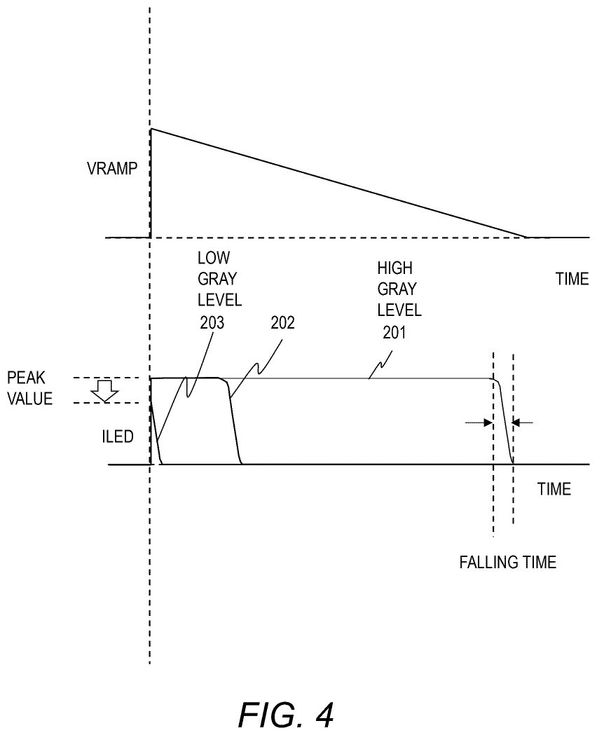

FIG. 4 schematically illustrates the waveforms of the ramp signal VRAMP and the LED currents ILED in response to different gray-level data voltages. The waveform 201 is the waveform of the driving current for a high gray level; the waveform 202 is the waveform of the driving current for an intermediate gray level; and the waveform 203 is the waveform of the driving current for a low gray level. For example, the maximum gray level is 255 and the minimum gray level is 0.

The waveforms 201 and 202 for the high gray level and the intermediate gray level have pulse widths longer than their falling times and their peak values (highest current values) are the same. The waveforms 201 and 202 have a period showing a constant (maximum) current value. In the waveforms 201 and 202, the driving current rises to the maximum value, maintains the maximum value, and then falls. The pulse width here is defined as the time width between the medians (the half value of the maximum value) in the rising edge and the falling edge of the waveform (half-value width). The rising edge can be regarded as substantially vertical.

The waveform 203 of the driving current for a low gray level has a pulse width shorter than the falling time and the peak value (highest current value) is lower than those of the other waveforms 201 and 202. The waveform 203 starts falling immediately after reaching the highest value and does not have a period showing a constant value. When the pulse width of the driving current is shorter than the falling time like this case, the peak value of the driving current becomes lower. That is to say, the density of the current flowing through the LED is low, causing variations in brightness and chromaticity among LEDs. A long falling time of the LED current has larger effects on the emission for the low gray-level range.

The falling time of the LED current ILED depends on the response time (rising time) of the control signal voltage VOUT output from the PWM circuit 12. Accordingly, reduction in response time of the control signal voltage VOUT output from the PWM circuit 12 is important.

The inventors found, through their research on the constant current PWM driving of a micro-LED, that the response of the PWM circuit 12 or the falling of the LED current ILED is correlated to the drain current of the driving thin-film transistor 121 in the PWM circuit 12. Specifically, they found that one cause of the gentle falling (long falling time) of the LED current ILED is the unnecessary drain current Id when the absolute value |Vgs| of the gate-source voltage of the PWM driving thin-film transistor 121 is small.

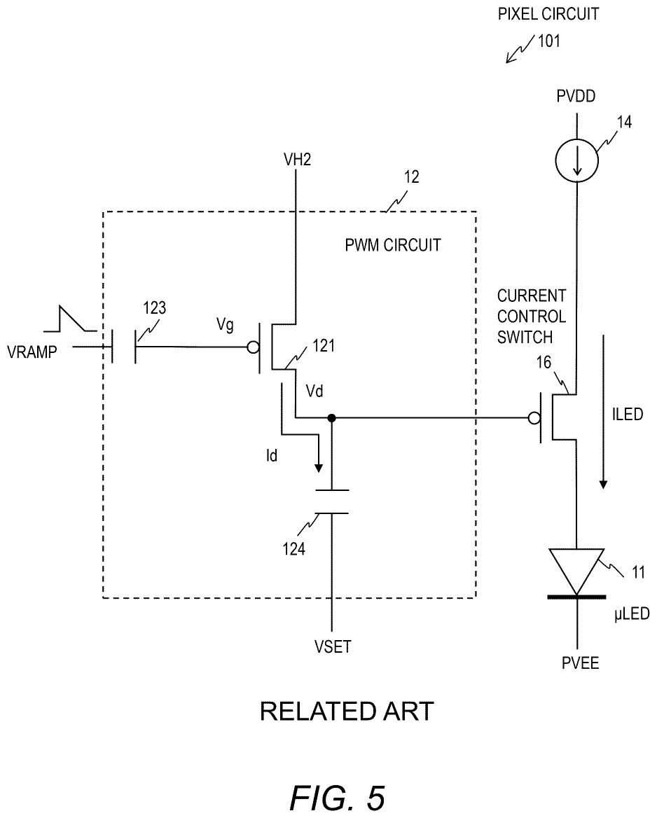

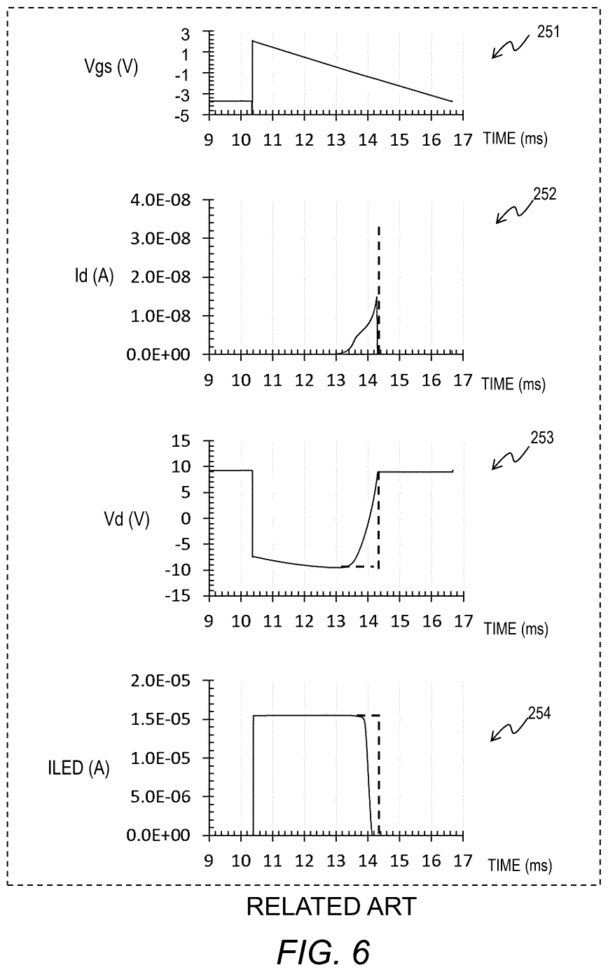

FIG. 5 illustrates a pixel circuit 101 of a related art configured by removing the supplemental thin-film transistor 122 from the pixel circuit 10 in FIG. 1. In FIG. 5, some elements shown in FIG. 1 are omitted. FIG. 6 illustrates characteristics of the pixel circuit 101 of the related art. FIG. 6 provides graphs indicating characteristics of the PWM driving thin-film transistor 121 and the waveform of the LED current. In each graph, the solid line represents the simulation result of the pixel circuit of the related art and the broken line represents the ideal value.

The graph 251 indicates temporal variation of the gate-source voltage Vgs of the PWM driving thin-film transistor 121. The gate voltage Vg of the PWM driving thin-film transistor 121 is the same as VIN in FIG. 2. The graph 252 indicates temporal variation of the drain current Id of the PWM driving thin-film transistor 121.

The graph 253 indicates temporal variation of the drain voltage Vd of the PWM driving thin-film transistor 121. The drain voltage Vd is equal to the control signal voltage VOUT in the pixel circuit of the related art that does not include the supplemental thin-film transistor 122. The graph 254 indicates temporal variation of the LED current ILED. The reference potential of the voltage for which a specific reference is not referred to is the system ground (0 V in this example).

The drain current Id of the PWM driving thin-film transistor 121 increases with increase in the absolute value of the gate-source voltage of the PWM driving thin-film transistor 121. The electric charge Q(t) stored in the capacitor 124 because of the drain current Id is expressed by the following formula:

$$Q ( t ) = \int Id ( t ) dt = C \times ( Vd ( t ) - Vd ( 0 ) ) ,$$

where C represents the capacitance of the capacitor 124 and Vd(0) corresponds to the constant voltage VSET.

By differentiating the both sides of the above formula by t, the following relation is obtained:

$$Id ( t ) = C \times dVd ( t ) / dt .$$

When the capacitor 124 has been charged, the drain-source voltage Vds of the PWM driving thin-film transistor 121 becomes 0, so that the drain current Id rapidly gets close to 0 and stops flowing. Since the charge Q of the capacitor 124 is CV, the waveform of the drain current Id is important for the rise of the control signal voltage VOUT of the PWM circuit 12 or the falling characteristic of the LED current.

As indicated in the graph 252 in FIG. 6, unnecessary high drain current Id flows within the pixel circuit 101 of the related art in a time period where the ramp signal starts falling. This drain current Id is caused by the kink effect when the gate voltage Vg of the PWM driving thin-film transistor 121 is higher than the source voltage VH2, in other words, the absolute value |Vgs| of the gate-source voltage is small and the absolute value |Vd| of the drain voltage is large. Because of this unnecessary drain current Id, the capacitor 124 is gradually charged; the drain voltage Vd or the control signal voltage VOUT starts rising gently from around the time 13 ms as indicated in the graph 253. As a result, the LED current ILED cannot keep the high current (peak value) and starts falling gently, as indicated in the graph 254.

The pixel circuit in an embodiment of this disclosure includes a supplemental thin-film transistor 122 between the drain of the driving thin-film transistor 121 of the PWM circuit 12 and the capacitor 124 as illustrated in FIG. 1. The gate of the supplemental thin-film transistor 122 is supplied with a constant voltage VREF. As will be described later, the supplemental thin-film transistor 122 functions to keep the drain current Id of the PWM driving thin-film transistor 121 constant, reducing the unnecessary current when the absolute value |Vgs| of the gate-source voltage of the PWM driving thin-film transistor 121 is small.

Now, a detailed configuration example of a pixel circuit 10 in an embodiment of this disclosure is described. FIG. 7 illustrates the detailed configuration example of the pixel circuit 10. One or more circuit elements can be added between the circuit elements directly connected in FIG. 7 and/or one or more circuit elements can be excluded from the circuit elements shown in FIG. 7.

The PWM circuit 12 in the configuration example of FIG. 7 consists of eight thin-film transistors and two capacitive elements. The constant current circuit 14 consists of five thin-film transistors and one capacitive element. The two circuits 12 and 14 can include any number of transistors and capacitors; the number can be the same or different between the two circuits 12 and 14. These circuits can include other kinds of circuit elements such as resistive elements.

The PWM circuit 12 in FIG. 7 includes transistor M11 to M15 in addition to the thin-film transistors 121, 122, and 125 described with reference to FIG. 1. The thin-film transistor 126 is excluded. The PWM circuit 12 further includes the capacitors 123 and 124 described with reference to FIG. 1. The transistors M11 to M15 are p-type switching thin-film transistors.

In the following description, the term “source/drain” means either the source or the drain. In some thin-film transistors, the source and the drain interchange depending on the direction of the flowing current. Although the sources and the drains of some thin-film transistors are fixed, the term “source/drain” may be used for convenience of the description.

The source of the thin-film transistor M11 is supplied with a power-supply voltage VH2 and the drain is connected to the source of the driving thin-film transistor 121 and one source/drain of the transistor M12. The gate of the thin-film transistor M11 is supplied with a control signal PWM_EM.

The gate of the thin-film transistor M12 is supplied with a scanning signal PWM_S2. One source/drain of the thin-film transistor M12 is connected to the drain of the thin-film transistor M11 and the source of the thin-film transistor 121; the other source/drain is supplied with a gray-level data voltage PWM_DATA. The gray-level data voltage PWM_DATA corresponds to the gray-level data voltage VDATA in FIG. 1.

The gate of the PWM driving thin-film transistor 121 is connected to one end of the capacitor 123, a source/drain of the thin-film transistor M13, and a source/drain of the thin-film transistor M14. The other end of the capacitor 123 is supplied with a ramp signal (ramp voltage) VRAMP. The source of the PWM driving thin-film transistor 121 is connected to the drain of the transistor M11 and a source/drain of the transistor M12. The drain of the PWM driving thin-film transistor 121 is connected to a source/drain of the thin-film transistor M13 and the source of the thin-film transistor M15.

The gate of the thin-film transistor M13 is supplied with the scanning signal PWM_S2. One source/drain of the thin-film transistor M13 is connected to the drain of the thin-film transistor 121 and the source of the thin-film transistor M15; the other source/drain is connected to the gate of the thin-film transistor 121 and a source/drain of the thin-film transistor M14.

The gate of the thin-film transistor M14 is supplied with a scanning signal PWM_S1. The scanning signal PWM_S1 is a scanning signal earlier than the scanning signal PWM_S2 by one horizontal period. The source of the thin-film transistor M14 is connected to the gate of the thin-film transistor 121 and a source/drain of the transistor M13. The drain of the thin-film transistor M14 is supplied with a constant initializing voltage VINI3.

The gate of the thin-film transistor M15 is supplied with the control signal PWM_EM. The source of the thin-film transistor M15 is connected to the drain of the thin-film transistor 121 and a source/drain of the thin-film transistor M13. The drain of the thin-film transistor M15 is connected to the source of the supplemental thin-film transistor 122.

The gate of the supplemental thin-film transistor 122 is supplied with a constant voltage VREF. The source of the supplemental thin-film transistor 122 is connected to the drain of the thin-film transistor M15. The drain of the supplemental thin-film transistor 122 is connected to the source of the thin-film transistor 125. The control signal voltage VOUT is output from a node N1 between the drain of the thin-film transistor 122 and the source of the thin-film transistor 125.

The gate of the thin-film transistor 125 is supplied with a control signal PWM_SE. The source of the thin-film transistor 125 is connected to the gate of the thin-film transistor 16 and the drain of the thin-film transistor 122. The drain of the thin-film transistor 125 is supplied with a constant voltage VSET. The capacitor 124 is connected between the source and the drain of the thin-film transistor 125.

The gray-level data voltage PWM_DATA is written to the capacitor 123 via the thin-film transistors M12, 121, and M13. Subsequently, the variation of the ramp signal VRAMP is superimposed to the capacitor 123.

The constant current control circuit 13 includes a constant current circuit 14, a current control switch 16, and thin-film transistors M31 and M32. The constant current circuit 14 includes thin-film transistors M21 to M25 and a capacitor C21. The thin-film transistors M21 to M25 are p-type thin-film transistors and the thin-film transistor M23 is a driving transistor to determine the magnitude of the constant current. The constant current circuit 14 controls the constant current by pulse amplitude modulation (PAM). This control is called PAM control.

The gate of the thin-film transistor M21 is supplied with a control signal PAM_EM. The source of the thin-film transistor M21 is supplied with a constant power-supply voltage PVDD; the drain is connected to a source/drain of the thin-film transistor M22 and the source of the thin-film transistor M23.

The gate of the thin-film transistor M22 is supplied with a scanning signal PAM_S2. One source/drain of the thin-film transistor M22 is supplied with a data voltage PAM_DATA for controlling the constant current; the other source/drain is connected to the drain of the thin-film transistor M21 and the source of the thin-film transistor M23.

The gate of the transistor M23 is connected to the capacitor C21, a source/drain of the thin-film transistor M24, and a source/drain of the thin-film transistor M25. The source of the thin-film transistor M23 is connected to the drain of the thin-film transistor M21 and a source/drain of the thin-film transistor M22. The drain of the thin-film transistor M23 is connected to an output node N2 of the constant current circuit 14.

The gate of the transistor M24 is supplied with the scanning signal PAM_S2. One source/drain of the thin-film transistor M24 is connected to the output node N2 of the constant current circuit 14; the other source/drain is connected to the gate of the thin-film transistor M23, the capacitor C21, and a source/drain of the transistor M25.

The gate of the thin-film transistor M25 is supplied with a scanning signal PAM_S1. The scanning signal PAM_S1 is a scanning signal earlier than the scanning signal PAM_S2 by one horizontal period. One source/drain of the thin-film transistor M25 is supplied with a constant voltage VINI2; the other source/drain is connected to the gate of the thin-film transistor M23, the capacitor C21, and a source/drain of the thin-film transistor M24.

The current value data PAM_DATA is written to the capacitor C21 via the thin-film transistors M22, M23, and M24. The thin-film transistor M23 outputs a current in accordance with the voltage of the capacitor C21 to the output node N2.

The current control switch 16 is a p-type thin-film transistor; its source is connected to the output node N2 of the constant current circuit 14 and its drain is connected to the source of the thin-film transistor M31. The gate of the current control switch 16 is supplied with the control signal voltage VOUT from the PWM circuit 12.

A p-type thin-film transistor M31 is connected between the anode of the micro-LED 11 and the current control switch 16. The thin-film transistor M31 is a switch; its gate is supplied with the control signal PAM_EM. The source of the transistor M31 is connected to the drain of the current control switch 16 and the drain is connected to the anode of the micro-LED 11.

The thin-film transistor M32 is a switch; its gate is supplied with the scanning signal PAM_S2. The thin-film transistor M32 is a p-type thin-film transistor. The source of the thin-film transistor M32 is connected to the anode of the micro-LED 11 and the drain is supplied with a constant power-supply voltage VINI1.

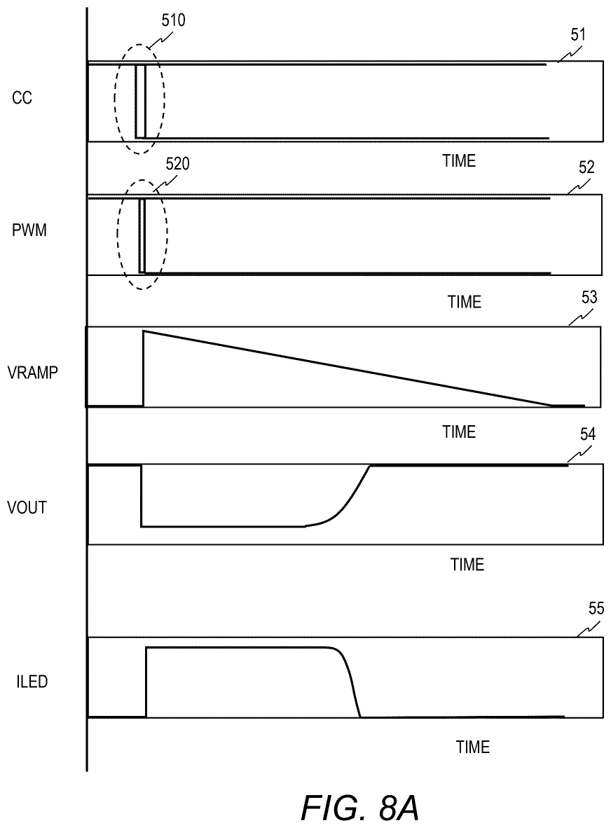

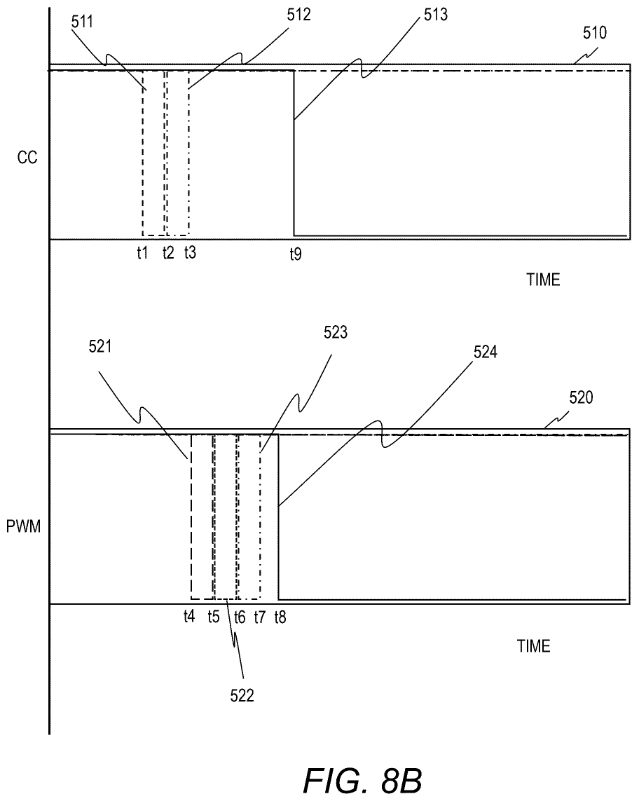

FIG. 8A is a sequence diagram illustrating temporal variation in one frame of signals in a pixel circuit 10. The horizontal axes of the graphs 51 to 54 represent the time and the vertical axes represent the voltage. The horizontal axis of the graph 55 represents the time and the vertical axis represents the current. The graph 51 indicates temporal variation of the control signals (CC) for the constant current circuit 14. The graph 52 indicates temporal variation of the control signals (PWM) for the PWM circuit 12. In FIG. 8A, each of the graphs 51 and 52 schematically illustrates temporal variation of a plurality of controls signals. The specifics of the signals in the period surrounded by the broken line 510 in the graph 51 and the period surrounded by the broken line 520 in the graph 52 are indicated in FIG. 8B.

The graph 53 indicates temporal variation of the ramp signal VRAMP to be input to the PWM circuit 12. The graph 54 indicates temporal variation of the control signal VOUT output from the PWM circuit 12. The graph 55 indicates temporal variation of the driving current ILED for the micro-LED 11.

FIG. 8B indicates the temporal variation of the signals in the period surrounded by the broken line 510 in the graph 51 and the temporal variation of the signals in the period surrounded by the broken line 520 in the graph 52. The horizontal axes of the graphs 510 and 520 represent the time and the vertical axes represent the voltage of the signals.

The graph 510 indicates the temporal variation of the control signals (CC) for the constant current circuit 14. In the graph 510, the line 511 indicates the temporal variation of the signal PAM_S1; the line 512 indicates the temporal variation of the signal PAM_S2; and the line 513 indicates the temporal variation of the signal PAM_EM.

The signal PAM_S1 (line 511) is a pulse signal that changes from a high level to a low level at a time t1 and changes from the low level to the high level at a time t2. The signal PAM_S2 (line 512) is a pulse signal that changes from a high level to a low level at the time t2 and returns from the low level to the high level at a time t3. The signal PAM_EM (line 513) is a pulse signal that changes from a high level to a low level at a time t9 and changes from the low level to the high level at a not-shown predetermined time in the frame period. In an example, the pulse widths of the signals PAM_S1 and PAM_S2 are one horizontal period.

The graph 520 indicates the temporal variation of the control signals (PWM) for the PWM circuit 12. In the graph 520, the line 521 indicates the temporal variation of the signal PWM_S1; the line 522 indicates the temporal variation of the signal PWM_S2; the line 523 indicates the temporal variation of the signal PWM_SE; and the line 524 indicates the temporal variation of the signal PWM_EM.

The signal PWM_S1 (line 521) is a pulse signal that changes from a high level to a low level at a time t4 and changes from the low level to the high level at a time t5. The signal PWM_S2 (line 522) is a pulse signal that changes from a high level to a low level at the time t5 and returns from the low level to the high level at a time t6. The signal PWM_SE (line 523) is a pulse signal that changes from a high level to a low level at a time t6 and returns from the low level to the high level at a time t7. The signal PWM_EM (line 524) is a pulse signal that changes from a high level to a low level at a time t8 and changes from the low level to the high level at a not-shown predetermined time in the frame period. In an example, the pulse widths of the signals PWM_S1, PWM_S2, and PWM_SE are one horizontal period.

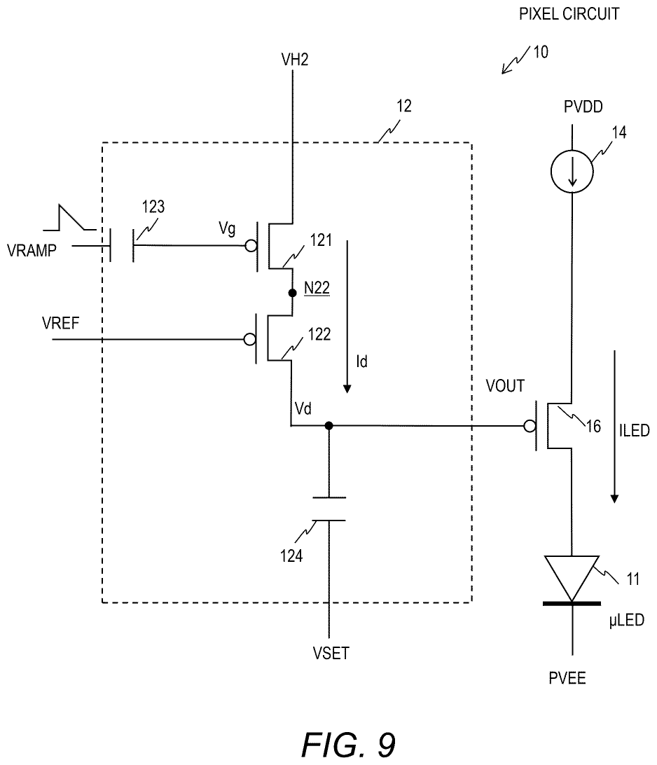

FIG. 9 illustrates a simplified circuit configuration of the pixel circuit 10 illustrated in FIG. 7. FIG. 9 only shows thin-film transistors that are in a conductive state and act important roles when the micro-LED 11 is receiving high current and emitting light. In an emission period, the thin-film transistors M21, M23, 16, M31, M11, 121, M15, and 122 are in a conductive (non-blocking) state. Among these thin-film transistors, the transistors M21, M23, M31, M11, and M15 can be regarded as short-circuited. The switching thin-film transistors in blocking states and the power supply-voltages supplied thereto are also omitted in FIG. 9.

The emission control switching thin-film transistor M15 between the driving thin-film transistor 121 of the PWM circuit 12 and the supplemental thin-film transistor 122 is omitted in FIG. 9. The emission control switching thin-film transistor M15 is optional. In either configuration, the drain of the PWM driving thin-film transistor 121 is connected to the source of the supplemental thin-film transistor 122 by electrical or circuit connection.

FIG. 9 further shows the gate voltage Vg of the PWM driving thin-film transistor 121, the drain current Id and the drain voltage Vd of the supplemental thin-film transistor 122, an intermediate node N22 between the thin-film transistors 121 and 122, and the LED current ILED.

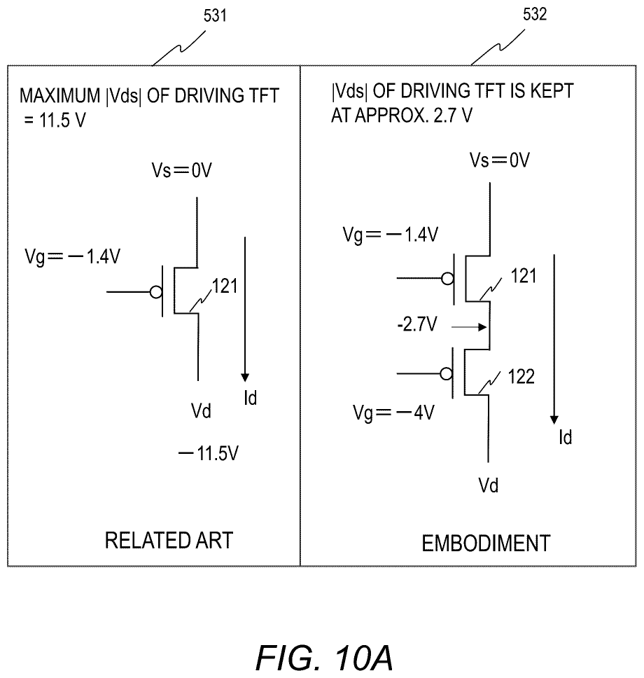

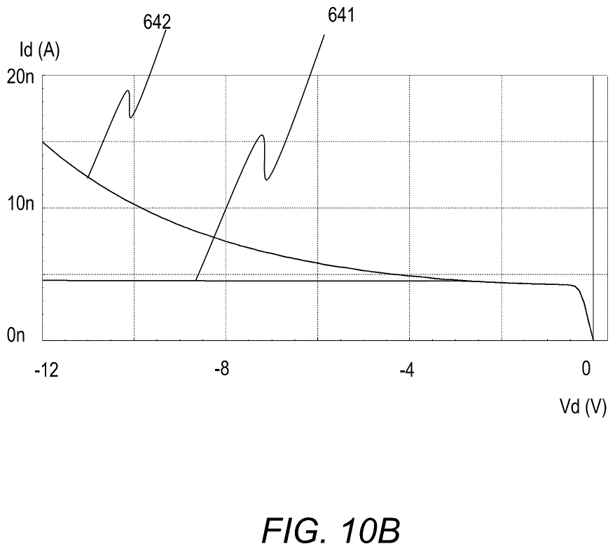

FIG. 10A is a diagram to explain the function of the supplemental thin-film transistor 122. The section 531 provides examples of the values of characteristics of a pixel circuit of a related art that does not include a supplemental thin-film transistor 122 when the driving thin-film transistor 121 of the PWM circuit 12 is ON. The section 532 provides examples of the values of characteristics of a pixel circuit including a series circuit of the PWM driving thin-film transistor 121 and the supplemental thin-film transistor 122 when the series circuit is ON.

In the section 531 of the related art, assume that the gate voltage Vg of the PWM driving thin-film transistor 121 is −1.4 V and the source voltage Vs is constantly 0 V. Also, assume that the maximum value for the absolute value |Vds| of the drain-source voltage Vds is 11.5 V. Because of the kink effect, the drain current Id of the PWM driving thin-film transistor 121 increases with increase in |Vds|. This unnecessary drain current Id gradually raises the control signal voltage VOUT and as a result, the rising time of the control signal voltage VOUT increases. 132 In the section 532 of an embodiment of this disclosure, assume that the gate voltage Vg of the PWM driving thin-film transistor 121 is −1.4 V, the source voltage Vs is constantly 0 V, and the gate voltage Vg of the supplemental thin-film transistor 122 is −4 V. The absolute value |Vds| of the drain-source voltage Vds of the PWM driving thin-film transistor 121 is kept at approximately 2.7 V. This phenomenon is explained in the following.

This embodiment divides the drain voltage to two thin-film transistors 121 and 122. Even if the drain voltage Vd of the series circuit (the supplemental thin-film transistor 122) increases as the capacitor 124 is charged, the potential at the intermediate node between two thin-film transistors 121 and 122 is automatically adjusted to keep the drain current Id constant.

Since |Vds| of the PWM driving thin-film transistor 121 is kept low (up to 2.7 V), the load connected to the drain of the PWM driving thin-film transistor 121 prevents the drain current Id from varying and reduces the unnecessary drain current. That is to say, the PWM driving thin-film transistor 121 functions as a current source. Since constant current flows in the supplemental thin-film transistor 122 and the gate potential of the supplemental thin-film transistor 122 is fixed, the source potential of the supplemental thin-film transistor 122 varies automatically.

The drain voltage Vd of the supplemental thin-film transistor 122 rises with time. Even if |Vds| of the supplemental thin-film transistor 122 becomes smaller, Vs of the supplemental thin-film transistor 122 rises somewhat. That is to say, |Vgs| of the supplemental thin-film transistor 122 becomes larger to keep the drain current Id constant.

Specifically, instead of |Vds| of the supplemental thin-film transistor 122 becoming smaller, |Vgs| of the supplemental thin-film transistor 122 becomes larger not to vary the drain current Id. Even if the threshold voltage Vth of the supplemental thin-film transistor 122 shifts, Vgs of the supplemental thin-film transistor 122 is automatically adjusted to equalize the drain current of the supplemental thin-film transistor 122 to the drain current of the PWM driving thin-film transistor 121. The drain current Id kept constant suppresses the unnecessary drain current Id when |Vg| of the PWM driving thin-film transistor 121 is small and enables the control signal voltage VOUT from the PWM circuit 12 to have a steeper rise with high current under a large |Vgs|.

FIG. 10B provides simulation results on the Id-Vd characteristic of a pixel circuit without a supplemental thin-film transistor 122 and a pixel circuit with a supplemental thin-film transistor 122. In the graph of FIG. 10B, the horizontal axis represents the drain voltage Vd and the vertical axis represents the drain current Id. The curve 641 represents the simulation result of the pixel circuit including a supplemental thin-film transistor 122. The curve 642 represents the simulation result of the pixel circuit that does not include a supplemental thin-film transistor 122.

As indicated by the curve 642 in FIG. 10B, the pixel circuit without a supplemental thin-film transistor 122 shows increase in drain current Id caused by the kink effect in the range where the absolute value |Vd| of the drain voltage is large. In contrast, the pixel circuit including a supplemental thin-film transistor 122 keeps the drain current Id constant as indicated by the curve 641. That is to say, when |Vds|=11.5V, the unnecessary Id is low in the curve 641.

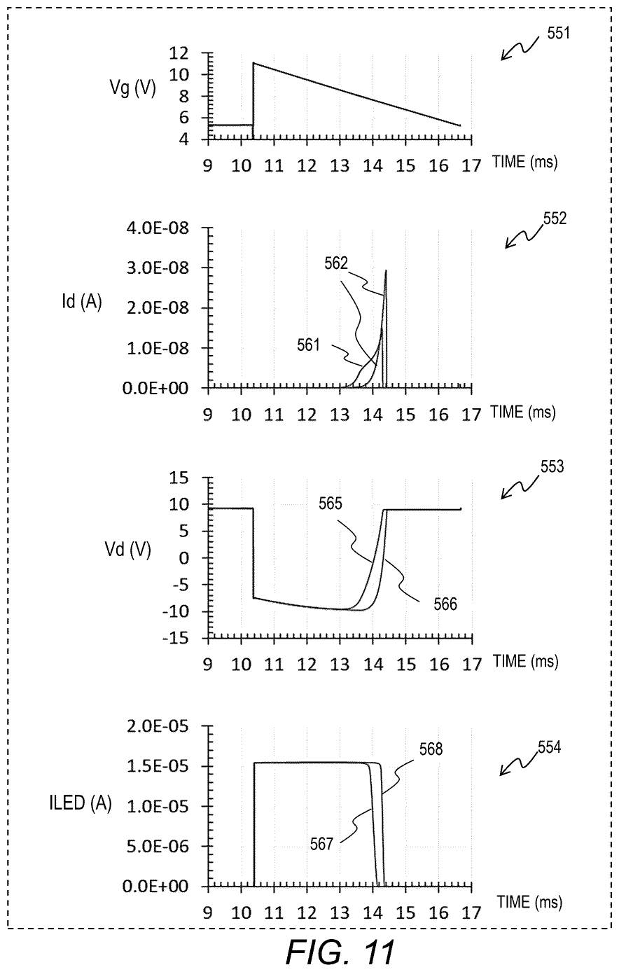

FIG. 11 is a chart to explain the effects of the pixel circuit 10 in an embodiment of this disclosure. The graphs 551 to 554 provide simulation results of a pixel circuit of a related art that does not include a supplemental thin-film transistor 122 and a pixel circuit in an embodiment of this disclosure that includes a supplemental thin-film transistor 122.

The graph 551 indicates temporal variation of the gate voltages Vg of the PWM driving thin-film transistors 121 in the related art and this embodiment. The graph 552 indicates temporal variation of the drain currents Id of the PWM driving thin-film transistor 121 in the related art and the series circuit (the supplemental thin-film transistor 122) in this embodiment. In the graph 552, the curve 561 represents the drain current Id in the related art and the curve 562 represents the drain current Id in this embodiment. The areas of the two waveforms are equal. This is because the time-integrated value of Id or the charge stored in the capacitor 124 is only determined by the capacitance, VH2, and VSET. To distinguish the waveforms, two leader lines from two points are shown on the curve 562. The waveform 561 of the related art is identical to the waveform in the solid line in the graph 252 in FIG. 6.

The graph 553 indicates temporal variation of the drain voltage Vd of the PWM driving thin-film transistor 121 in the related art and the drain voltage Vd of the series circuit (the supplemental thin-film transistor 122) in this embodiment. The curve 565 represents the drain voltage Vd in the related art and the curve 566 represents the drain voltage Vd in this embodiment. The graph 554 indicates temporal variation of the LED currents ILED. The curve 567 represents the LED current ILED in the related art and the curve 568 represents the LED current ILED in this embodiment.

In both of the related art and this embodiment, the drain current Id increases when the gate voltage Vg of the PWM driving thin-film transistor 121 decreases or the absolute value |Vgs| of the gate-source voltage increases with time. In the related art illustrated in FIG. 6, the capacitor 124 is gradually charged because of the unnecessary drain current Id when |Vgs| of the PWM driving thin-film transistor 121 is small, so that the LED current ILED starts falling gently.

In the series circuit in this embodiment, the waveform of the drain current Id shifts rightward and has a high peak value, compared to the current waveform of the related art. This embodiment first keeps low drain current Id until |Vgs| reaches a value that makes high drain current Id and charges the capacitor 124 in a short time. For this reason, steep falling of the LED current is attained.

According to the simulation results, the pixel circuit 10 with a supplemental thin-film transistor 122 in this embodiment reduces the falling time of the LED current by an average of 31% in the entire gray level region, compared to the pixel circuit without a supplemental thin-film transistor 122 of the related art.

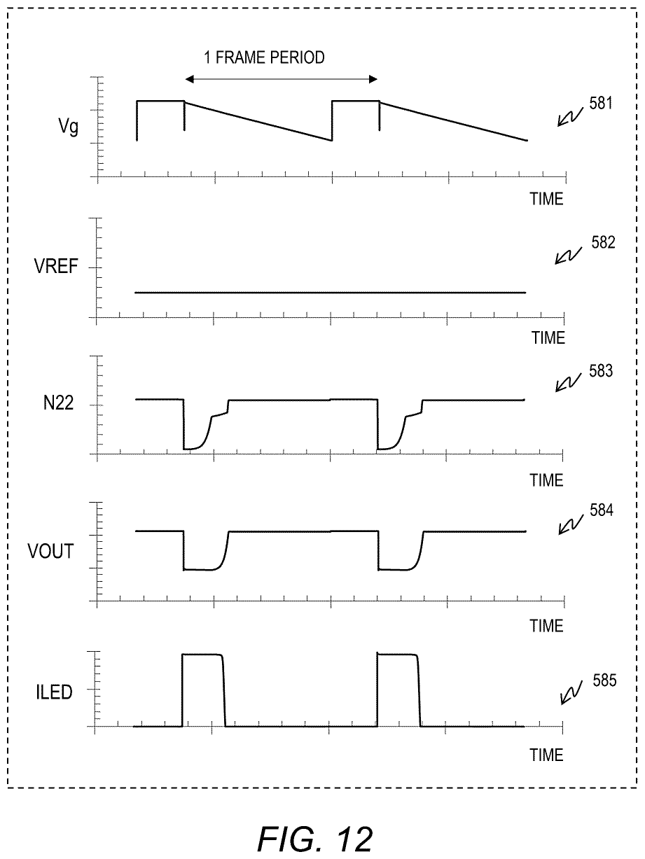

FIG. 12 provides simulated waveforms of the gate voltage, the source voltage, and the drain voltage of the supplemental thin-film transistor 122 in this embodiment. FIG. 12 provides waveforms in two frame periods. The graph 581 indicates temporal variation of the input voltage Vg to the gate of the PWM driving thin-film transistor 121. The graph 582 indicates temporal variation of the input voltage VREF to the gate of the supplemental thin-film transistor 122.

The graph 583 indicates temporal variation of the potential at the intermediate node N22 between two thin-film transistors 121 and 122 in FIG. 9 (the source of the supplemental thin-film transistor 122). The graph 584 indicates temporal variation of the control signal voltage VOUT from the PWM circuit 12. This is the drain voltage of the supplemental thin-film transistor 122. The graph 585 indicates temporal variation of the LED current ILED.

As indicated in the graph 582, the input voltage VREF to the gate of the supplemental thin-film transistor 122 is fixed throughout each frame period.

### Embodiment 2

Embodiment 2 describes the control voltage VREF for the supplemental thin-film transistor 122 described in Embodiment 1. As described in Embodiment 1, the supplemental thin-film transistor 122 supplied with a constant control voltage VREF at the gate can reduce the falling time of the LED current ILED. The inventors'research revealed that the gate voltage VREF of the supplemental thin-film transistor 122 has an appropriate range to reduce the falling time more effectively.

Specifically, the inventors found that VREF has effect to reduce the falling time of the LED current ILED when it is at least equal to or higher than the negative power-supply voltage VGL (the minimum voltage) to be supplied to the PWM circuit 12. The inventors further found that the upper limit for the constant gate voltage VREF lowers as the positive power-supply voltage VH2 for the PWM circuit 12 lowers. The gate voltage VREF in the following range can reduce the falling time of the LED current ILED more effectively:

$$VGL < VREF \leq VH 2 - 1.5 .$$

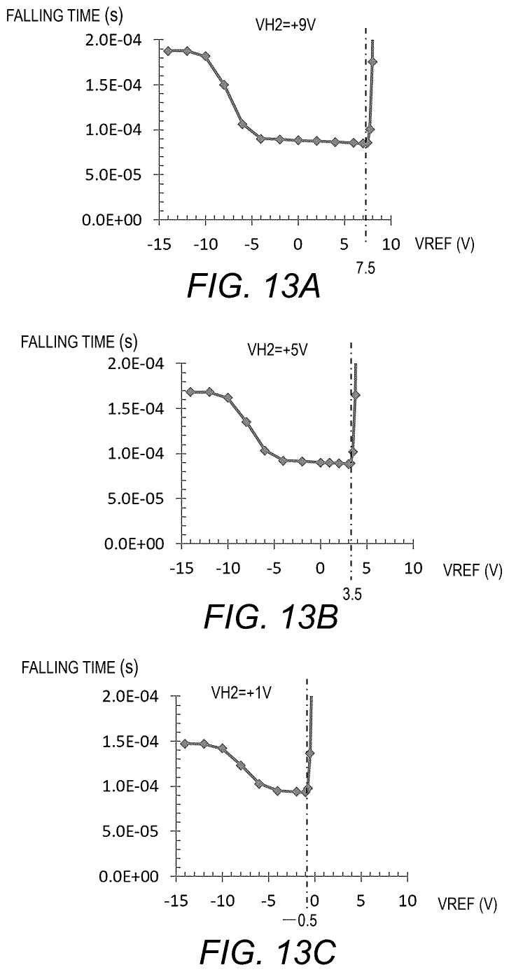

FIGS. 13A, 13B, and 13C provide simulation results on the relation between the constant voltage VREF and the falling time of the LED current ILED when different power-supply voltages VH2 are supplied to the PWM circuit 12 in a pixel circuit in an embodiment of this disclosure. FIG. 13A provides the simulation result when the power supply voltage VH2 is 9 V. FIG. 13B provides the simulation result when the power supply voltage VH2 is 5 V. FIG. 13C provides the simulation result when the power supply voltage VH2 is 1 V.

With reference to FIG. 13A, the falling time drastically increases when the constant voltage VREF exceeds 7.5 V. With reference to FIG. 13B, the falling time drastically increases when the constant voltage VREF exceeds 3.5 V. With reference to FIG. 13C, the falling time drastically increases when the constant voltage VREF exceeds −0.5 V.

As indicated in the simulation results in FIGS. 13A, 13B, and 13C, when the gate voltage VREF exceeds the voltage lower than the positive power-supply voltage VH2 for the PWM circuit 12 by 1.5 V (VH2−1.5), the falling time drastically increases. The same results were obtained when the positive power-supply voltage VH2 took other values. As for the lower limit, when the gate voltage VREF is −5 V or higher, large effect of reducing the falling time was obtained. When the gate voltage VREF was smaller than VGL, the falling time was almost equal to the one in the conventional art. This is because the supplemental thin-film transistor 122 fully turns ON and the supplemental thin-film transistor 122 merely has a short-circuited function.

Examples of the values of the constant voltages to be supplied to the pixel circuit 10 in FIG. 7 are provided. An example of the negative power-supply voltage VGL is −12 V. The voltage VSET for the output voltage VOUT of the PWM circuit 12 at the start of light emission can be equal to the negative power-supply voltage VGL. An example of the negative power-supply voltage PVEE for the cathode of the micro-LED 11 is −8 V. An example of the positive power-supply voltage VH2 for the PWM circuit 12 is 1 V. An example of the positive power-supply voltage PVDD for the constant current circuit 14 is 0 V. Examples for the initialization voltages VINI1, VINI2, VINI3 are −3 V.

An embodiment of this disclosure shares a power line for supplying the gate voltage to the supplemental thin-film transistor 122 with another power-supply voltage (constant voltage). Sharing an existing power line without newly adding a power line attains a smaller layout area (footprint) of the circuit.

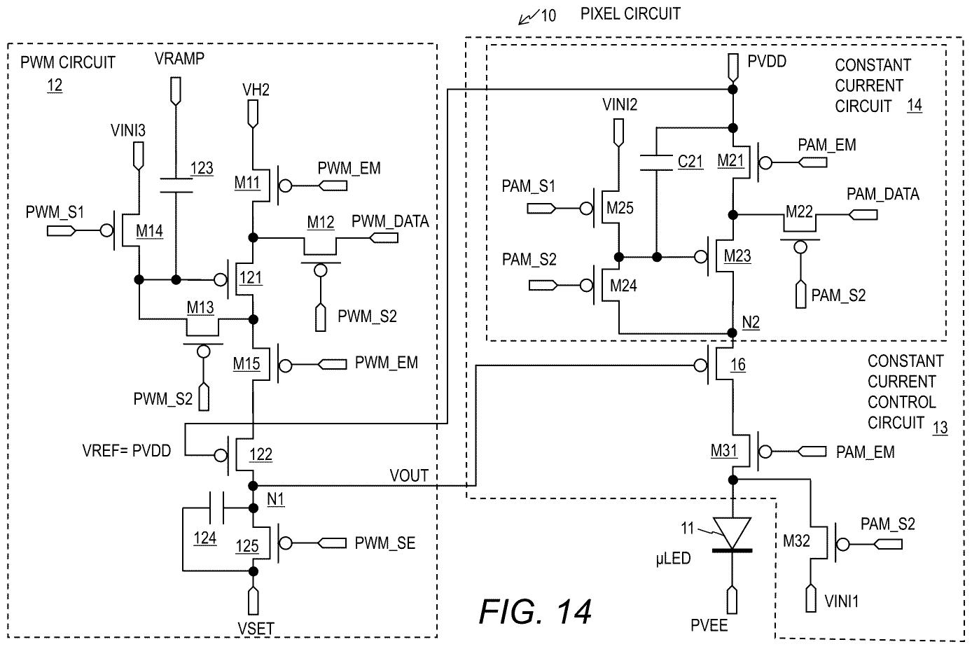

FIG. 14 illustrates a configuration example of a pixel circuit in the case where the positive power-supply voltage VH2 for the PWM circuit 12 is 9 V. The gate of the supplemental thin-film transistor 122 is supplied with the positive power-supply voltage PVDD=4.6 V for the constant current circuit 14. The power line for the positive power-supply voltage PVDD is connected to the gate of the supplemental thin-film transistor 122 to supply the positive power-supply voltage PVDD as the gate voltage VREF.

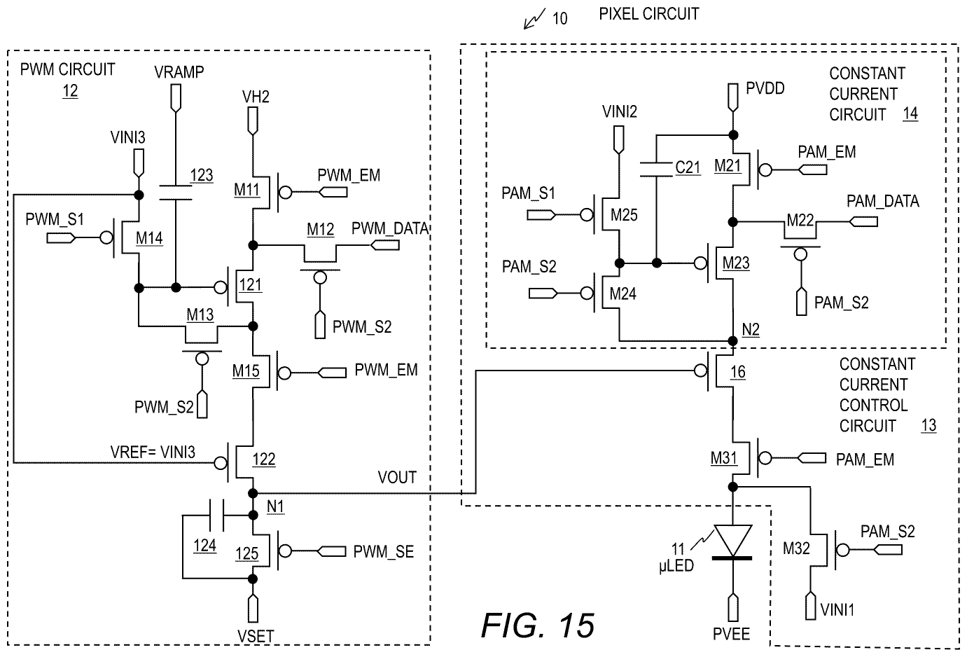

FIG. 15 illustrates a configuration example of a pixel circuit in the case where the positive power-supply voltage VH2 for the PWM circuit 12 is 1 V. The gate of the supplemental thin-film transistor 122 is supplied with the initialization power-supply voltage VINI3=−3 V for the PWM circuit 12. The power line for the initialization power-supply voltage VINI3 is connected to the gate of the supplemental thin-film transistor 122 to supply the initialization power-supply voltage VINI3 as the gate voltage VREF.

### Embodiment 3

The capacitor 124 has a role to keep the output voltage VOUT of the PWM circuit 12 low. The PWM circuit 12 writes the negative power-supply voltage VSET to VOUT to turn ON the thin-film transistor 16. As a result, the LED current starts flowing to light the micro-LED 11. The inventors'research revealed that the capacitance C of the capacitor 124 has an appropriate range to reduce the falling time of the LED current more effectively in a pixel circuit including a supplemental thin-film transistor 122. Specifically, when the capacitance C of the capacitor 124 satisfies the following condition, the falling time of the LED current is reduced more effectively:

$$10 fF \leq C \leq 300 fF .$$

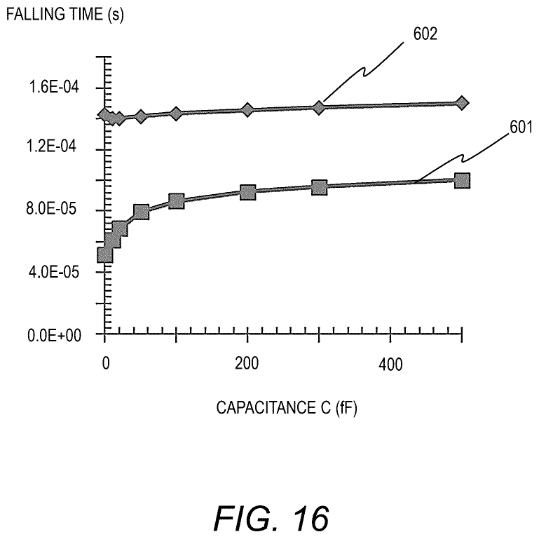

FIG. 16 provides simulation results on the relation between the capacitance C of the capacitor 124 and the falling time. The curve 601 represents the simulation result of a pixel circuit 10 including a supplemental thin-film transistor 122 in an embodiment of this disclosure. The curve 602 is the simulation result of the pixel circuit without a supplemental thin-film transistor 122 of a related art. As understood from FIG. 16, the falling time in the related art is almost uniform even if the capacitance C of the capacitor 124 is varied.

However, the falling time of the LED current in the pixel circuit 10 in this embodiment decreases as the capacitance C of the capacitor 124 becomes smaller. Incidentally, when the capacitance C is 0 fF, the waveform of the LED current ILED collapses.

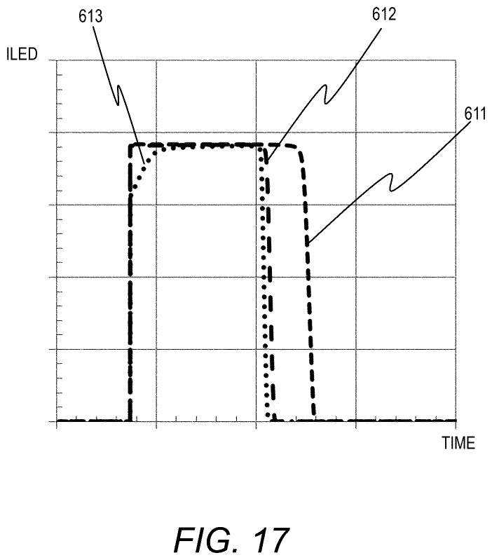

FIG. 17 provides simulation results on the LED current ILED in the cases where different capacitances C are employed in the pixel circuit 10 including a supplemental thin-film transistor 122 in this embodiment. The horizontal axis represents the time and the vertical axis represents the amount of the LED current ILED. The curve 611 indicates the LED current ILED when the capacitance C=300 fF. The curve 612 indicates the LED current ILED when the capacitance C=10 fF. The curve 613 indicates the LED current ILED when the capacitance C=0 fF.

As indicated in the simulation results in FIG. 17, the waveform of the LED current when the capacitance C=0 fF collapses immediately after the LED current starts rising. A certain capacitance is necessary to keep the gate potential of the current control switch 16. The simulation results in FIG. 17 indicate that the capacitance C of 10 fF attains a proper LED current waveform. When the transistor 125 turns ON and writes the negative power-supply voltage VSET to VOUT, parasitic capacitance such as the capacitance between the gate and the source of the transistor 125 affects the writing. If the capacitance of the capacitor 124 is not enough, VOUT cannot be sufficiently lowered. Then, the thin-film transistor 16 does not fully turn ON, making the peak value of the rising LED current low. For this reason, the capacitor 124 needs a certain amount of capacitance.

### Embodiment 4

Embodiments 1, 2, and 3 describe pixel circuits including p-type thin-film transistors. Embodiment 4 describes a pixel circuit including n-type thin-film transistors. For example, all thin-film transistors in the pixel circuit 10 illustrated in FIG. 7 can be n-type thin-film transistors or only one or more of the thin-film transistors can be n-type thin-film transistors. These apply to all embodiments.

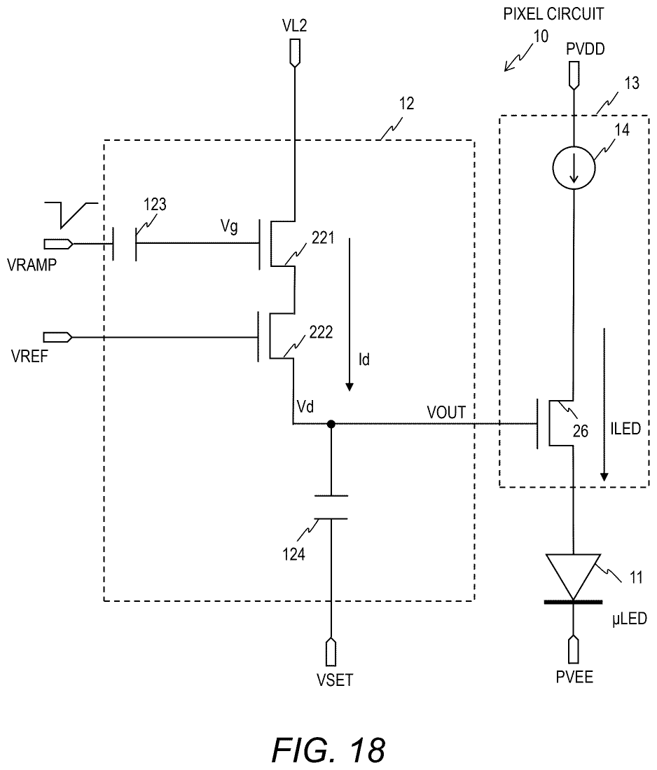

FIG. 18 illustrates an example where the p-type transistors in the simplified pixel circuit 10 illustrated in FIG. 9 are replaced with n-type thin-film transistors. In FIG. 18, the driving thin-film transistor 221 of the PWM circuit 12 and the supplemental thin-film transistor 222 are n-type thin-film transistors. Furthermore, the current control switch 26 is an n-type thin-film transistor.

The source of the driving thin-film transistor 221 is supplied with a negative power-supply voltage VL2 instead of the positive power-supply voltage VH2 indicated in FIG. 9. The power-supply voltage VSET is a positive power-supply voltage. The positive voltage is written to VOUT to turn ON the thin-film transistor 26, so that the LED current (lighting current) starts flowing to light the micro-LED 11. The falling time of the LED current can be reduced more effectively when the gate voltage of the supplemental thin-film transistor 222 satisfies the following condition:

$$VL 2 + 1 \text{.5} \leq VREF < VGH ,$$

where VGH represents the high voltage of the control signal (pulse signal) and for example, it can be 8 V. The power-supply voltage VSET can be VGH and VL2 can be −12 V, for example.

### Embodiment 5

Embodiment 5 describes configurations of the driving thin-film transistor 121 of a PWM circuit 12. In Embodiment 5, the supplemental thin-film transistor 122 can be excluded from the pixel circuit 10 or remain there.

The inventors found that the structure of the PWM driving thin-film transistor 121 affects the falling time of the LED current. Specifically, they found that the channel length L of the PWM driving thin-film transistor 121 in a specific range can reduce the falling time of the LED current more effectively.

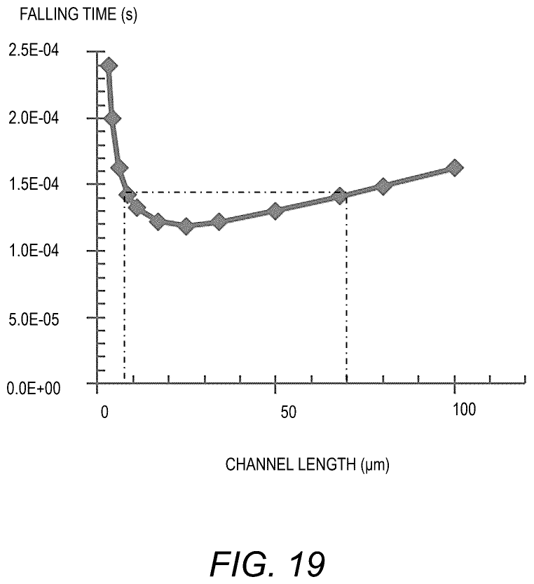

FIG. 19 provides a simulation result on the relation between the channel length of the PWM driving thin-film transistor 121 and the falling time of the LED current. In the graph of FIG. 19, the horizontal axis represents the channel length and the vertical axis represents the falling time of the LED current. The simulation was conducted using a pixel circuit that does not include a supplemental thin-film transistor 122.

With reference to FIG. 19, the falling time monotonically decreases as the channel length L increases from 0, reaches the minimum value (smallest value) when the channel length L is 25 μm, and then monotonically increases. Reversely, the falling time monotonically decreases as the channel length L decreases from 100 μm, reaches the minimum value (smallest value), and then monotonically increases.

One reason for the long falling time in a short channel range is inferred that the capacitor 124 is charged because of the unnecessary current caused by the kink effect. One reason why the falling time increases from the minimum value with increase in the channel length L of the PWM driving thin-film transistor 121 is inferred that the S-value of the transistor 121 increases with increase in the channel length L. As the S-value increases, which means that the Id-Vg characteristic becomes gentler in the range lower than the threshold voltage, the variation in VOUT becomes gentler.

The graph of FIG. 19 indicates that the falling time drastically increases with decrease in the channel length L from 8.5 μm. Furthermore, the falling time when the channel length L is 70 μm is almost equal to the falling time when the channel length L is 8.5 μm. The channel length L for the PWM driving thin-film transistor 121 can be selected from the following range including the value when the falling time is the shortest (best):

$$8.5 μm < L \leq 70 μm .$$

Another feature for the structure of the PWM driving thin-film transistor 121 can be a double-gate structure. The double-gate structure includes two separate gate electrodes and these two gate electrodes are supplied with the same gate potential. The two gate electrodes are both disposed above or under the channel with respect to the substrate. Note that the description provided so far has been provided assuming that all the thin-film transistors including the PWM driving thin-film transistor 121 have a single-gate structure.

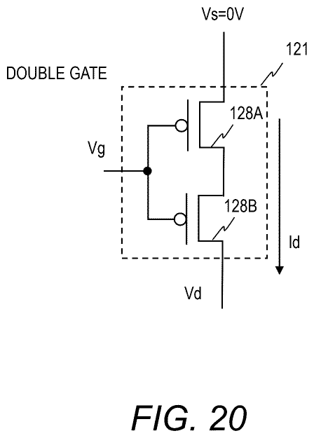

FIG. 20 is a circuit diagram illustrating the configuration of a PWM driving thin-film transistor 121 having a double-gate structure. In the circuit diagram, the PWM driving thin-film transistor 121 consists of two thin-film transistors 128A and 128B connected in series and their gates are supplied with the same gate voltage Vg. An example of the device structure can include two separate gate electrodes opposed to a single highly-resistive semiconductor region and these gate electrodes are connected to a common gate line. It is not excluded that the thin-film transistors other than the PWM driving thin-film transistor 121 have the double-gate structure.

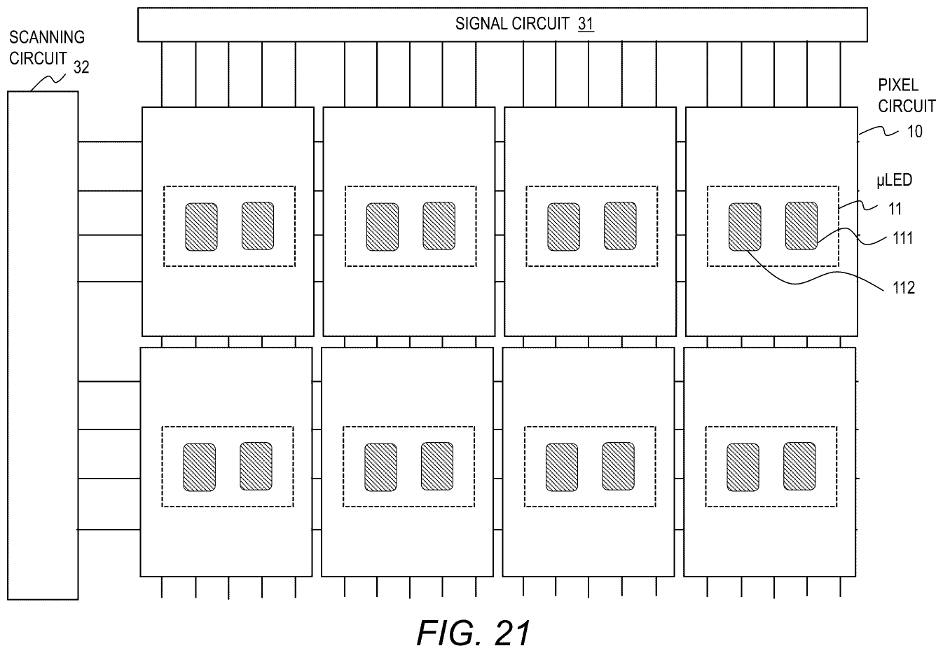

Hereinafter, a configuration example of a micro-LED display device is described. The following description is applicable to all of the foregoing embodiments. FIG. 21 is a plan diagram illustrating a configuration example of a micro-LED display device. The micro-LED display device includes a display region including an array of pixel circuits 10 and micro-LEDs 11, a signal circuit 31, and a scanning circuit 32.

Each of the signal circuit 31 and the scanning circuit 32 or the combination of these circuits are a driver circuit (also referred to as control circuit) for driving and controlling the pixel circuits 10. The signal circuit 31 and the scanning circuit 32 supply control signals and power-supply voltages for controlling the pixel circuits 10. For example, the signal circuit 31 supplies power-supply voltages (constant voltages) and data voltages PWM_DATA and PAM_DATA for the PWM circuit 12 and the constant current circuit 14 to each pixel circuit 10.

The scanning circuit 32 outputs scanning signals including the selection signals and emission control signals for the PWM circuits 12 and the constant current circuits 14, for example. The scanning signals include PWM_S1, PWM_S2, PWM_EM, PWM_SE, PAM_S1, PAM_S2, and PAM_EM. The kinds of the output signals from the driver circuits depend on the configuration of the pixel circuit.

A pixel circuit 10 controls a micro-LED 11. The elements of the pixel circuit 10 is fabricated on a thin-film transistor (TFT) substrate. The micro-LED 11 is connected to connection pads 111 and 112 on the TFT substrate to be electrically connected to the pixel circuit 10 through the connection pads 111 and 112.

### Embodiment 6

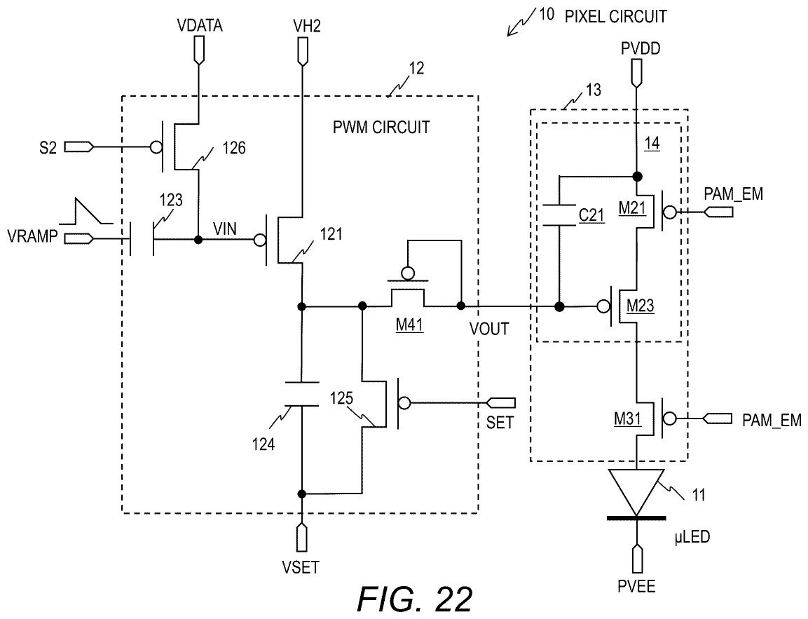

FIG. 22 schematically illustrates the configuration of a pixel circuit in another embodiment of this disclosure. The pixel circuit of this disclosure can include other elements in addition to the elements shown in FIG. 22 and/or exclude one or more of the elements shown in FIG. 22. The direct connection between circuit elements shown in FIG. 22 can be electrical or circuit connection.

Differences from the configuration example of a pixel circuit illustrated in FIG. 1 are mainly described. Compared to the pixel circuit in FIG. 1, the supplemental thin-film transistor 122 in the PWM circuit 12 is excluded and a thin-film transistor M41 for controlling the constant current circuit 14 is added. Compared to the pixel circuit configuration in FIG. 1, the constant current control switch 16 is excluded from the constant current control circuit 13.

The constant current circuit 14 includes the thin-film transistors M21 and M23, and the capacitor C21 in the circuit configuration in FIG. 7. The thin-film transistor M23 is a constant current driving transistor to determine the magnitude of the constant current. The gate of the thin-film transistor M23 is connected to one end of the capacitor C21 and the other end of the capacitor C21 is connected to the power line for the constant voltage PVDD.

The constant current control circuit 13 includes the thin-film transistor M31 shown in FIG. 7. The source of the thin-film transistor M31 is connected to the drain of the thin-film transistor M23 and the drain of the thin-film transistor M31 is connected to the anode of the micro-LED 11.

In the pixel circuit in FIG. 22, the gate of the thin-film transistor M41 is electrically connected to one source/drain of the thin-film transistor M41. The source/drain of the thin-film transistor M41 electrically connected to its gate is connected to the gate of the thin-film transistor M23 that is the driving transistor of the constant current circuit 14. The other source/drain of the thin-film transistor M41 is connected to the drain of the PWM driving thin-film transistor 121. Since the drain potential of the PWM driving thin-film transistor 121 varies, each source/drain of the p-type thin-film transistor M41 changes between a source and a drain depending on the magnitude relation between the drain potential of the thin-film transistor 121 and the gate potential of the thin-film transistor M23 in such a manner that the source/drain connected to the higher potential becomes a source and the source/drain connected to the lower potential becomes a drain.

The drain of the PWM driving thin-film transistor 121 is connected to the source of the switching thin-film transistor 125 and one end of the capacitor 124. The drain of the switching thin-film transistor 125 and the other end of the capacitor 124 are supplied with a constant voltage VSET. The gate of the PWM driving thin-film transistor 121 is controlled by the same manner as the one in the pixel circuit in FIG. 1.

A feature of the pixel circuit in this embodiment is that the thin-film transistor M41 is interposed between the drain of the PWM driving thin-film transistor 121 and the gate of the constant current driving thin-film transistor M23 and the gate of the thin-film transistor M41 is connected to the gate of the constant current driving thin-film transistor M23.

When the thin-film transistor M41 turns from OFF to ON, the drain of the PWM driving thin-film transistor 121 and the gate of the constant current driving thin-film transistor M23 are electrically connected. In other words, the constant current driving thin-film transistor M23 controls not only the magnitude of the LED current but also ON/OFF of the LED current. For this reason, the thin-film transistor dedicated to the ON/OFF control of the LED current (e.g., the current control switch 16 in the pixel circuit in FIG. 1 or 7) is not necessary.

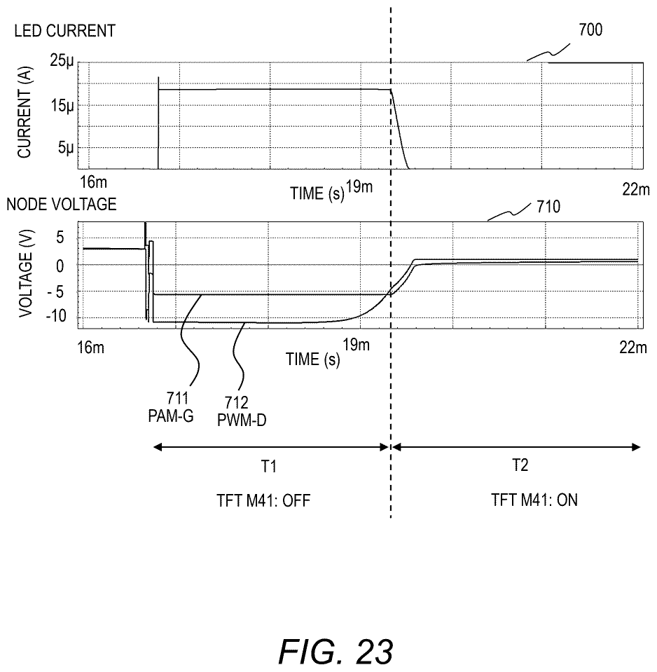

FIG. 23 illustrates temporal variation of the LED current, the drain voltage of the PWM driving thin-film transistor 121 (PWM-D voltage), and the gate voltage of the constant current driving thin-film transistor M23 (PAM-G voltage) in the pixel circuit illustrated in FIG. 22. The graph 700 indicates the temporal variation of the LED current. The graph 710 indicates the temporal variation of the PWM-D voltage and the PAM-G voltage. The horizontal axis and the vertical axis of the graph 700 represent the time and the LED current, respectively.

The horizontal axis and the vertical axis of the graph 710 represent the time and the node voltage, respectively. In the graph 710, the curves 711 and 712 represent the PAM-G voltage and the PWM-D voltage, respectively. In a period T1, the gate potential of the transistor M23 (VOUT) is kept higher than the drain potential of the transistor 121. Since VOUT is the source potential of the transistor M41 and the source and the gate of the transistor M41 are connected, the gate-source voltage of the transistor M41 is 0 V. Accordingly, the constant current circuit control thin-film transistor M41 is OFF in the period T1 and is ON in the period T2 following the period T1.

At the beginning, the PWM-D voltage 712 increases gently but it is blocked by the thin-film transistor M41 and does not affect the PAM-G voltage 711.

Subsequently, the PWM-D voltage 712 further increases and exceeds the PAM-G voltage 711. Then, the drain and the source of the thin-film transistor M41 interchange. In other words, the drain of the PWM driving thin-film transistor 121 becomes the source of the thin-film transistor M41. When the gate-source voltage of the thin-film transistor M41 falls below the threshold voltage (Vgs<Vth), the constant current circuit control thin-film transistor M41 turns ON and the charge stored in the capacitor 124 moves to the capacitor C21 to increase the PAM-G voltage 711. That is to say, the LED current can be kept high for a while even after the PWM-D voltage 712 starts increasing. Accordingly, the LED current falls steeply in a short time.

As described above, the constant current circuit control thin-film transistor M41 allows the control switch for the constant current, or the current control switch 16, to be excluded. According to the inventors'research, Vds (the voltage drop) of the current control switch 16 located on the path of the LED current is large, causing the pixel circuit to consume large power. The pixel circuit in this embodiment eliminates the power consumption of the constant current control switch. In addition, the thin-film transistor M41 that operates as described above makes the falling edge of the LED current waveform steeper.

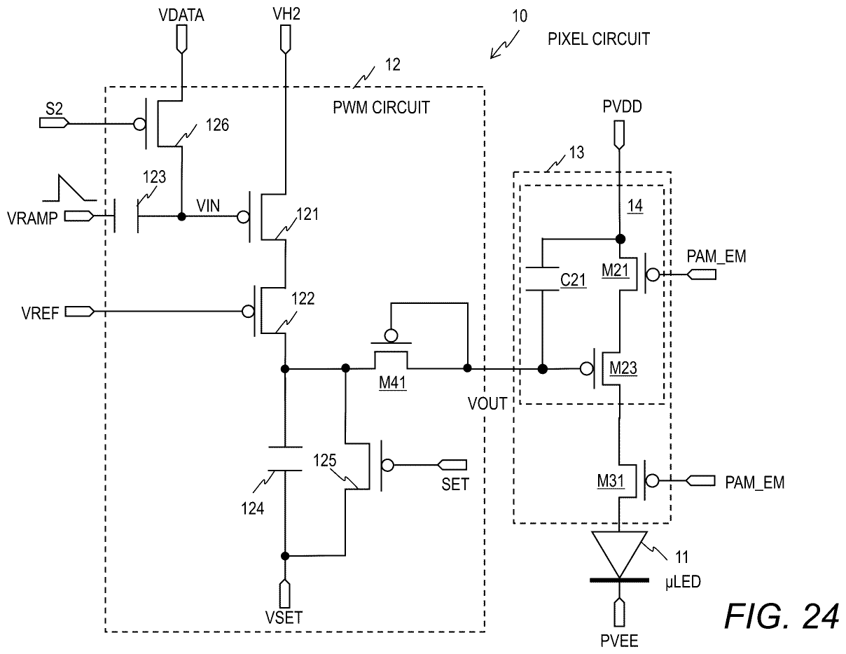

FIG. 24 schematically illustrates the configuration of a pixel circuit in still another embodiment of this disclosure. Differences from the pixel circuit illustrated in FIG. 22 are described. The pixel circuit in FIG. 24 includes the thin-film transistor 122 in the pixel circuit in FIG. 1, in addition to the pixel circuit in FIG. 22. The thin-film transistor 122 operates in the same manner as the one in the pixel circuit in FIG. 1; the pixel circuit in FIG. 24 including the thin-film transistor M41 (a third thin-film transistor) improves the steepness of the falling edge of the LED current waveform, especially in displaying low gray levels.

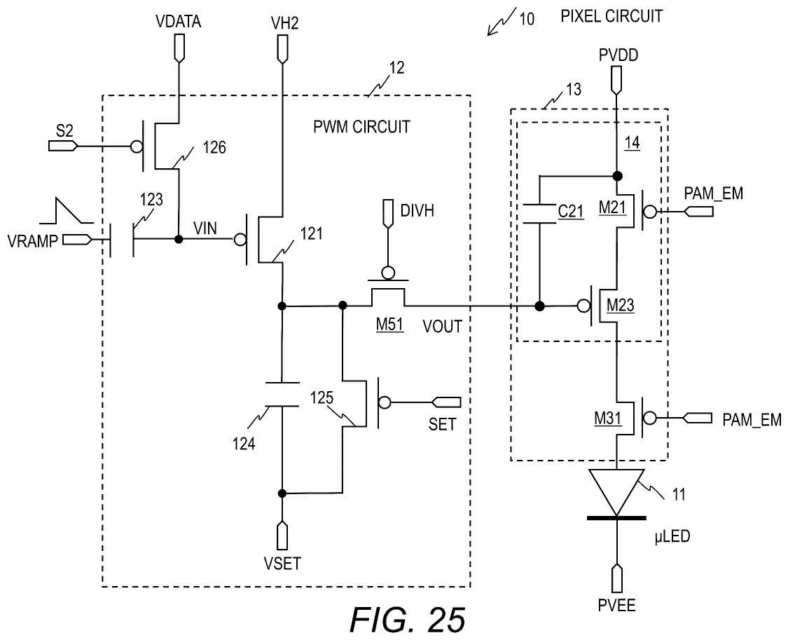

FIG. 25 schematically illustrates the configuration of a pixel circuit in still another embodiment of this disclosure. Differences from the pixel circuit illustrated in FIG. 22 are described. The pixel circuit in FIG. 25 includes a thin-film transistor M51 (an example of the second thin-film transistor) in place of the thin-film transistor M41 and its gate is supplied with a constant voltage (power-supply voltage) DIVH. The

other configuration is the same as that of the constant current circuit control thin-film transistor M41 and the constant current circuit control thin-film transistor M51 controls the gate voltage of the constant current driving thin-film transistor M23 (an example of the first thin-film transistor). The pixel circuit in FIG. 25 can further include a thin-film transistor 122 as illustrated in FIG. 24.

An embodiment of this disclosure specifies the constant voltage DIVH within the following range:

$$PAM - G voltage \leq DIVH \leq VH 2 + Vth ,$$

where the PAM-G voltage is defined as PAM_DATA +Vth and Vth is the threshold voltage of the constant current driving thin-film transistor M23; and PAM_DATA is current value data described with reference to FIG. 7.

For example, assuming that VH2=+1 V, Vth=−1.5 V, and PAM_DATA=−4 V, the constant voltage DIVH should be included in the following range:

$$- 5.5 V \leq DIVH \leq - 0.5 V .$$

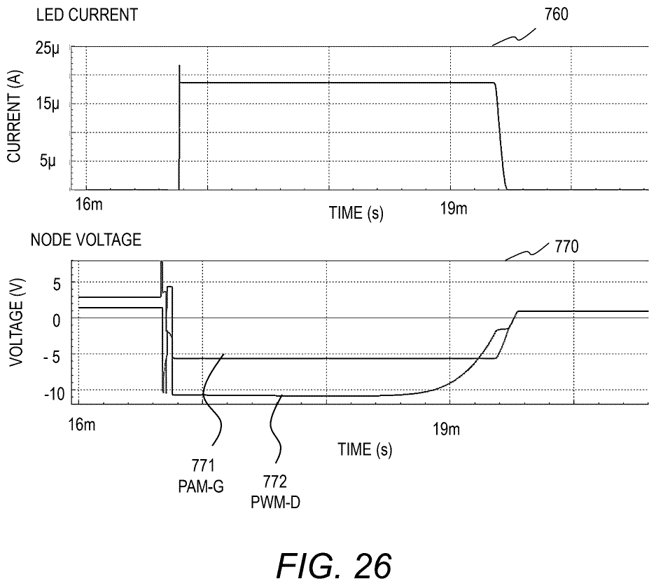

FIG. 26 illustrates temporal variation of the LED current, the drain voltage of the PWM driving thin-film transistor 121 (PWM-D voltage), and the gate voltage of the constant current driving thin-film transistor M23 (PAM-G voltage) in the pixel circuit illustrated in FIG. 25. The constant voltage DIVH is assumed to be −3 V. The graph 760 indicates the temporal variation of the LED current. The graph 770 indicates the temporal variation of the PWM-D voltage and the PAM-G voltage. The horizontal axis and the vertical axis of the graph 760 represent the time and the LED current, respectively. The horizontal axis and the vertical axis of the graph 770 represent the time and the node voltage, respectively. In the graph 770, the curves 771 and 772 represent the PAM-G voltage and the PWM-D voltage, respectively.

At the beginning, the PWM-D voltage 772 increases gently but it is blocked by the constant current circuit control thin-film transistor M51 and does not affect the PAM-G voltage 771. Subsequently, the PWM-D voltage 772 further increases and exceeds the PAM-G voltage 771. Then, the PWM-D voltage changes from the source voltage into the drain voltage for the thin-film transistor M51. When the gate-source voltage of the thin-film transistor M51 falls below the threshold voltage (Vgs<Vth), the thin-film transistor M51 turns ON and the charge stored in the capacitor 124 moves to the capacitor C21 to increase the PAM-G voltage 771.

Compared to the pixel circuit in FIG. 22, the gate voltage of the constant current circuit control thin-film transistor M51 is high, so that the PWM-D voltage to turn off the constant current circuit control thin-film transistor M51 is raised. The charge in the capacitor 124 is moved to the capacitor C21 after the PWM-D voltage has reached the voltage to completely turn off the constant current driving thin-film transistor M23, achieving a still shorter falling time of the LED current.

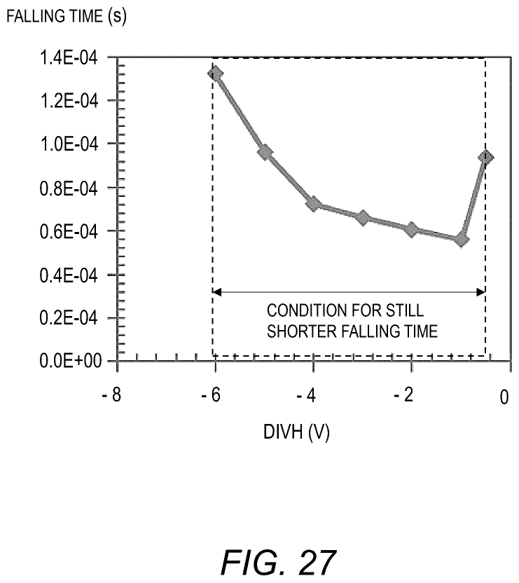

FIG. 27 provides a simulation result on the relation between the falling time of the LED current and the constant voltage DIVH. In the graph of FIG. 27, the horizontal axis represents the constant voltage DIVH and the vertical axis represents the falling time of the LED current. The positive power-supply voltage VH2 for the PWM circuit 12 is assumed to be +1 V. The range surrounded by a broken line satisfies the condition to achieve the still shorter falling time of the LED current.

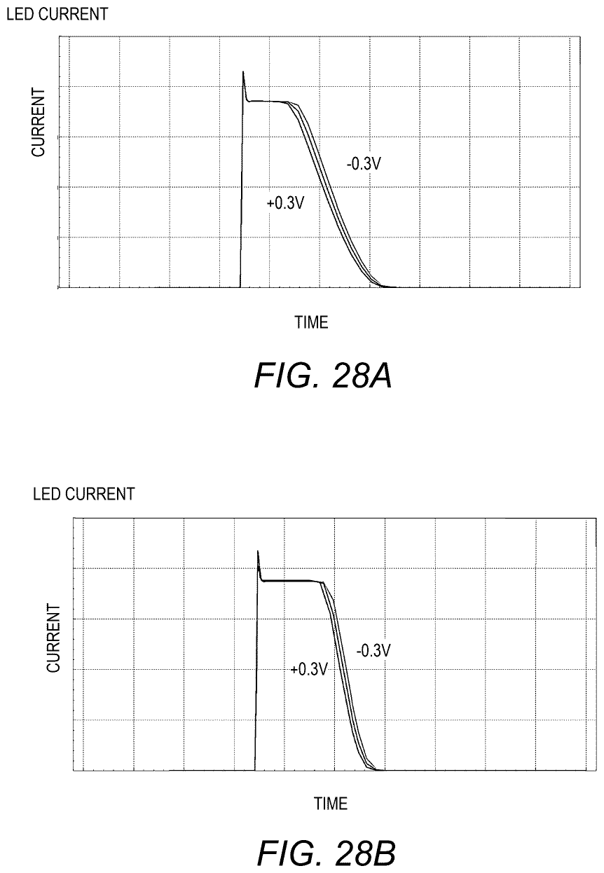

The inventors further conducted simulations using the pixel circuits in FIGS. 22 and 25. The results of the simulations are described in the following. FIG. 28A provides simulation results on the LED current waveform when using thin-film transistors M41 having different threshold voltages in the pixel circuit in FIG. 22. The horizontal axis represents the time and the vertical axis represents the LED current. 199 The simulation calculated waveforms of the LED current when the threshold voltage of the thin-film transistor M41 is the reference value and when the threshold voltage of the thin-film transistor M41 is at the values shifted from the reference value by ±0.3 V. As indicated in FIG. 28A, the effect of the threshold voltage shift of the thin-film transistor M41 on the LED current waveform is extremely small.

FIG. 28B provides simulation results on the LED current waveform when using thin-film transistors M51 having different threshold voltages in the pixel circuit in FIG. 25. The horizontal axis represents the time and the vertical axis represents the LED current. The simulation calculated waveforms of the LED current when the threshold voltage of the thin-film transistor M51 is the reference value and when the threshold voltage of the thin-film transistor M51 is at the values shifted from the reference value by ±0.3 V. As indicated in FIG. 28B, the effect of the threshold voltage shift of the thin-film transistor M51 on the LED current waveform is extremely small.

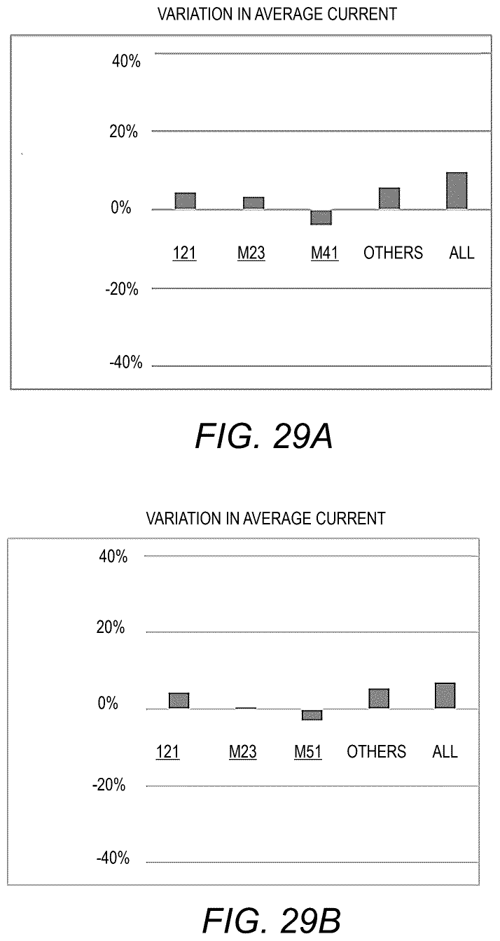

FIG. 29A provides simulation results on the effects of threshold voltage shifts of different thin-film transistors in the pixel circuit in FIG. 22 onto the average LED current. The vertical axis represents the variation rate (fluctuation rate) of the average LED current. The graph of FIG. 29A indicates the variation rates of the average LED current caused by threshold voltage shifts individually occurring in the thin-film transistors 121, M23, and M41. The graph of FIG. 29A further indicates the variation rate of the average LED current caused by threshold voltage shifts of all thin-film transistors other than the foregoing thin-film transistors (OTHERS) and the variation rate of the average LED current caused by threshold voltage shifts of all thin-film transistors (ALL).

With reference to the graph of FIG. 29A, the variation rate of the average LED current caused by the threshold voltage shifts of all thin-film transistors is positive. However, the variation rate of the average LED current caused by the threshold voltage shift of the thin-film transistor M41 alone is negative; it partially cancels the effect by the threshold voltage shifts of the other thin-film transistors.

FIG. 29B provides simulation results on the effects of threshold voltage shifts of different thin-film transistors in the pixel circuit in FIG. 25 onto the average LED current. The vertical axis represents the variation rate of the average LED current. The graph of FIG. 29B indicates the variation rates of the average LED current caused by threshold voltage shifts individually occurring in the thin-film transistors 121, M23, and M51. The graph of FIG. 29B further indicates the variation rate of the average LED current caused by threshold voltage shifts of all thin-film transistors other than the foregoing thin-film transistors (OTHERS) and the variation rate of the average LED current caused by threshold voltage shifts of all thin-film transistors (ALL).

With reference to the graph of FIG. 29B, the variation rate of the average LED current caused by the threshold voltage shifts of all thin-film transistors is positive. However, the variation rate of the average LED current caused by the threshold voltage shift of the thin-film transistor M51 alone is negative; it partially cancels the effect by the threshold voltage shifts of the other thin-film transistors.

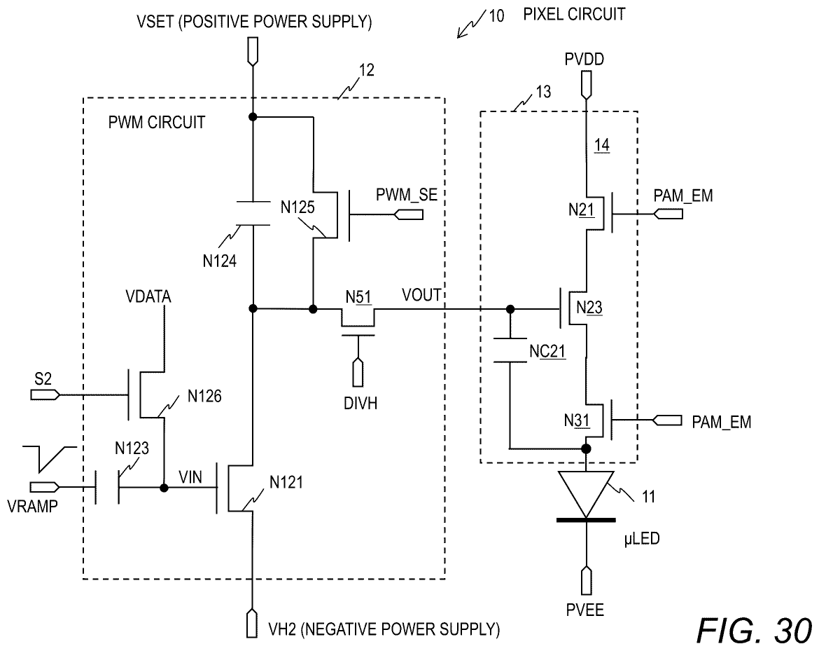

FIG. 30 schematically illustrates the configuration of a pixel circuit in still another embodiment of this disclosure. The pixel circuit in FIG. 30 is configured by replacing the p-type thin-film transistors in the pixel circuit in FIG. 25 with n-type thin-film transistors. Because of the change in the conduction type of the thin-film transistors, the polarities of the power-supply voltages VSET and VH2 are inverted.

The thin-film transistors N121, N125, N126, N51, N21, N23, and N31 in the pixel circuit in FIG. 30 respectively correspond to the thin-film transistors 121, 125, 126, M51, M21, M23, and M31 in the pixel circuit in FIG. 25. The capacitors N123, N124, and NC 21 in the pixel circuit in FIG. 30 respectively correspond to the capacitors 123, 124, and C21 in the pixel circuit in FIG. 25. The H-levels and the L-levels of the control signals for the switching transistors in the pixel circuit in FIG. 30 are inverted from those in the pixel circuit in FIG. 25.

In the pixel circuit in FIG. 30, the drain of the PWM driving thin-film transistor N121 is connected to the capacitor N124. The gate of the constant current driving thin-film transistor N23 is connected to the capacitor NC21. The thin-film transistor N51 is interposed between the drain of the PWM driving thin-film transistor N121 and the gate of the constant current driving thin-film transistor N23. The gate of the constant current circuit control thin-film transistor N51 is connected to the power line for supplying the constant voltage DIVH.

The specification on the numerical values for the pixel circuit in FIG. 25 are changed to meet the changes of the polarities of the thin-film transistors as follows:

$$VH 2 + Vth \leq DIVH \leq PAM - G voltage ,$$

where PAM-G voltage=PAM_DATA+Vth.

As to the pixel circuits described with reference to FIGS. 22 and 24, at least one p-type thin-film transistor can be replaced with an n-type thin-film transistor. As to the pixel circuit described with reference to FIGS. 25 and 30, one or more of the thin-film transistors can be p-type thin-film transistors and the other thin-film transistors can be n-type thin-film transistors. For example, in the case where the thin-film transistor M41 in the pixel circuit in FIG. 22 or 24 is an n-type thin-film transistor, its gate is connected to the gate of the constant current driving transistor. The condition for the capacitance C of the capacitor 124 described in Embodiment 3 is applicable to the pixel circuits in Embodiment 6.

As set forth above, embodiments of this disclosure have been described; however, this disclosure is not limited to the foregoing embodiments. Those skilled in the art can easily modify, add, or convert each element in the foregoing embodiments within the scope of this disclosure. A part of the configuration of one embodiment can be replaced with a configuration of another embodiment or a configuration of an embodiment can be incorporated into a configuration of another embodiment.

What is claimed is:

1. A pixel circuit configured to control a light-emitting element, the pixel circuit comprising:
a constant current control circuit including a first thin-film transistor, the constant current control circuit being configured to control current that flows in the light-emitting element; and
a pulse width modulation circuit configured to output a control signal for the first thin-film transistor based on a gray-level data voltage and a ramp signal input to the pulse width modulation circuit,
wherein the first thin-film transistor is configured to control the current that flows in the light-emitting element, and
wherein the pulse width modulation circuit includes:
a pulse width modulation driving thin-film transistor; and
a second thin-film transistor disposed between the pulse width modulation driving thin-film transistor and an output node of the control signal, a gate of the second thin-film transistor being configured to be supplied with a constant voltage.

2. The pixel circuit according to claim 1, wherein the first thin-film transistor is a switch.

3. The pixel circuit according to claim 1, wherein the first thin-film transistor is configured to control the magnitude of the current to flow in the light-emitting element and whether to cut off the current.

4. The pixel circuit according to claim 1, wherein the first thin-film transistor, the pulse width modulation driving thin-film transistor, and the second thin-film transistor are of the same conduction type.

5. The pixel circuit according to claim 1, wherein a switching thin-film transistor is disposed between the pulse width modulation driving thin-film transistor and the second thin-film transistor.

6. The pixel circuit according to claim 2,
wherein the second thin-film transistor is a p-type thin-film transistor, and
wherein a relation VGL<VREF≤VH2−1.5 V is satisfied, where VREF represents the constant voltage, VH2 represents a positive power-supply voltage for the pulse width modulation circuit, and VGL represents a low voltage of the control signal.

7. The pixel circuit according to claim 2,
wherein the second thin-film transistor is an n-type thin-film transistor, and
wherein a relation VL2+1.5 V≤VREF<VGH is satisfied, where VREF represents the constant voltage, VL2 represents a negative power-supply voltage for the pulse width modulation circuit, and VGH represents a high voltage of the control signal.

8. The pixel circuit according to claim 1, further comprising:
a capacitor between a gate of the first thin-film transistor and a power line,
wherein a drain of the pulse width modulation driving thin-film transistor and a source of the second thin-film transistor are connected, and
wherein the source or a drain of the second thin-film transistor is connected to an end of the capacitor and the gate of the first thin-film transistor.

9. The pixel circuit according to claim 8, wherein the capacitor has a capacitance not less than 10 fF and not more than 300 fF.

10. The pixel circuit according to claim 2,
wherein the constant voltage to be supplied to the gate of the second thin-film transistor is the same as another power-supply voltage for the pixel circuit, and
wherein the constant voltage and the power-supply voltage share a power line.

11. The pixel circuit according to claim 2,
wherein the constant current control circuit further includes a constant current circuit, and
wherein the first thin-film transistor is a switching thin-film transistor disposed between the constant current circuit and the light-emitting element.

12. The pixel circuit according to claim 3,
wherein the second thin-film transistor is a p-type thin-film transistor, and
wherein PAM-G≤DIVH≤VH2+Vth is satisfied, where DIVH represents the constant voltage, VH2 represents a positive power-supply voltage for the pulse width modulation circuit, PAM-G represents a gate voltage for the first thin-film transistor, and Vth represents the threshold voltage of the first thin-film transistor.

13. The pixel circuit according to claim 3,
wherein the second thin-film transistor is an n-type thin-film transistor, and
wherein VH2 +Vth≤DIVH≤PAM-G is satisfied, where DIVH represents the constant voltage, VH2 represents a negative power-supply voltage for the pulse width modulation circuit, PAM-G represents a gate voltage of the first thin-film transistor, and Vth represents threshold voltage of the first thin-film transistor.

14. The pixel circuit according to claim 1, further comprising:
a third thin-film transistor connected between a gate of the first thin-film transistor and a source or a drain of the second thin-film transistor,
wherein a gate of the third thin-film transistor is electrically connected to a source or a drain of the third thin-film transistor.
